(19) United States
(12) Patent Application Publication
(10) Pub. No.: US 2014/0270326 A1
(43) Pub. Date: Sep. 18, 2014

(54) Planar-Magnetic Transducer With Improved Electro-Magnetic Circuit

(71) Applicant: James J. Croft, III, Bellevue, WA (US)

(72) Inventor: James J. Croft, III, Bellevue, WA (US)

(21) Appl. No.: 14/207,213

(22) Filed: Mar. 12, 2014

Related U.S. Application Data
(60) Provisional application No. 61/792,561, filed on Mar. 15, 2013.

(51) Int. Cl. H04R 9/06; H04R 9/04; H04R 7/16; H04R 9/02; H04R 1/00; H04R 7/04

(52) U.S. Cl. CPC H04R 9/06; H04R 1/00; H04R 7/04; H04R 7/16; H04R 9/025; H04R 9/046; H04R 2400/00; H04R 2307/021
USPC 381/398

(57) ABSTRACT

The invention provides a planar-magnetic transducer with a frame and a primary magnet row structure of elongated magnets adjacent and air gapped from a first surface side of a mobile portion of a thin film or thin structure diaphragm with conductive traces incorporated with the diaphragm. An additional pair of magnetic sources attached to the frame outside of the vibratable region of the diaphragm and mounted above the plane of the opposite, second surface side of the diaphragm to enhance magnetic energy near the second surface side of the film diaphragm, without any magnet rows attached directly in front of the second surface side of the vibratable region of the diaphragm between the additional pair of magnetic sources. The additional magnetic sources can increase the drive force to the outer portions of the vibratable diaphragm, or across the diaphragm, to provide more control near the termination edge of the diaphragm and to create a more planar displacement of the diaphragm and increase transducer efficiency.

### RELATED APPLICATIONS

This application (Attorney's Ref. No. P217856) claims benefit of U.S. Provisional Application Ser. No. 61/792,561 filed Mar. 15, 2013, the contents of which are incorporated herein by reference.

### TECHNICAL FIELD

The present invention relates to planar magnetic loudspeaker transducers and systems, and more particularly, planar-magnetic transducers with flexible thin film diaphragms and conductive voice coil traces distributed across the thin film diaphragm.

### BACKGROUND AND RELATED ART

In the field of planar-magnetic loudspeakers, the prior art has been primarily made up of what are referred to as double-ended (or double-side driven), and single-ended (or single-side driven) devices, referring to either groups of magnet rows adjacent both surface sides of a thin film diaphragm, in the double-ended case, or magnet rows adjacent just one surface side of the diaphragm, representing a single-ended layout. Examples of both of these approaches are illustrated in, U.S. Pat. No. 3,674,946 “Electromagnetic Transducer” and U.S. Pat. No. 3,919,499 “Planar Speaker” both by James M. Winey, and U.S. Pat. No. 4,037,061 “Planar Pattern Voice Coil Audio Transducer” by Daniel R. von Recklinghausen. Applicant hereby incorporates herein by reference any U.S. patents and U.S. patent applications cited or referred to in this application.

Due to having magnets on both surface sides of the diaphragm, prior art double-ended devices can result in an increased and more confined magnetic field, but in exchange for the greater magnetic force they have had a number of limitations. Those shortcomings include a reduced ability to reproduce high frequencies accurately without linear distortions due to acoustic blockage and cavity effects from magnet structures both behind and in front of the vibratable diaphragm reducing acoustic transparency and causing cavity resonances, which can cause aberrations in the high frequency amplitude response and a low pass filter characteristic that can reduce high frequency bandwidth. Additional structural problems are caused by magnetic repulsion forces between the opposing front and back magnet structures centered over the active region of the diaphragm, particularly when high energy magnets are used, which require extensive bracing and/or heavy frame materials to attempt to offset frame flexing and minimize instabilities of diaphragm tension.

Both single-sided and double-sided prior art devices have a common limitation in that they tend to drive the active portion of the diaphragm with weaker force and/or reduced displacement at the outer most edge of the diaphragm and therefore, diaphragm excursions the center of the diaphragm can be much greater than at the outer portions of the diaphragm, causing both less effective use of diaphragm area, and a dynamic non-linear distortion due to changes in effective diaphragm area relative to diaphragm excursion.

Both single-ended and double-ended, devices also tend to have losses due to end conductor traces needing to be routed outside of the magnetic fields and causing resistive losses and un-driven portions of the diaphragm.

Additional limitations of prior art planar-magnetic transducers relate to reflections and standing waves that are due to film edge termination problems due to under-damped, uncontrolled diaphragm energy near the diaphragm edge termination points.

Also, the strongest flux lines at the outer most portion of the film diaphragm most often have the greatest intensity above or below, rather than in the plane of the film diaphragm such that they don't effectively engage the conductive traces on the diaphragm, and therefore contribute very little to the driving force of the outer portion of the diaphragm. This can result in reduced acoustic output and also in less control of the outer portions of the diaphragm, potentially causing frequency response errors.

Additionally, single-end driven planar magnetic transducers, generally do not have the magnetic force and output capability of a double-ended device. Solutions to the lack of diaphragm control have included mechanical damping of the film surface area and tend to be very lossy and raise the effective moving mass, which may cause further inefficiencies and limited control and utilization of the total diaphragm surface area. Also, as planar magnetic devices are made larger or wider to increase output, they tend to lose dispersion in the upper frequency ranges and in some cases beam the sound forward with overly restrictive directivity.

In an attempt to minimize resonances and interference in acoustic output in double-ended transducers caused by the acoustic opacity of magnets blocking acoustic output and resonances caused by the acoustic cavities, prior art solutions have been attempted, such as using thinner profile magnets adjacent one primary output surface side of the diaphragm in a double ended device, such as illustrated in U.S. Pat. No. 3,922,504 “Electroacoustic Transducer”, by Kenichiro Kishikawa, or reducing magnet count adjacent one surface side of a double-ended device, as illustrated in U.S. Pat. No. 6,934,402 “Planar-Magnetic Speakers with Secondary Magnetic Structure”, by James J. Croft III, et al. These approaches can offset part of the amplitude response problems of double-ended devices but still do not equal a one side, fully open, single-ended device in this regard.

It would be valuable to have a new planar magnetic transducer architecture that can improve planar-magnetic transducers by increasing magnetic field strength derived from both sides of the diaphragm, increasing magnetic force and acoustic output, and linearizing diaphragm mobilization while increasing control of the outer edges of the vibratable diaphragm as an improvement over a single-ended planar magnetic transducer without invoking the acoustical response errors and magnetic repulsion derived frame and diaphragm stability problems of a double-sided drive device.

### SUMMARY

The present invention provides a double-sided drive planar magnetic transducer with an acoustically transparent primary output side. The structure of the present invention provides a planar-magnetic transducer with a frame and a primary magnet structure including magnets adjacent to, and air-gapped from, a first surface side of the mobile portion of a thin film or substantially planar diaphragm with conductive traces integrated with, and distributed across a portion of the diaphragm. The diaphragm is attached around a periphery of the mobile portion of the diaphragm and held in a state of predetermined tension. At least one secondary magnetic structure is mounted on a plane relative to a second surface side of the diaphragm and outside of the edge of the vibratable portion of the diaphragm to realize a second side drive to increase in force applied at least near the outer edge of the mobile portion of the diaphragm to improve diaphragm control and/or to increase the excursion capability of the complete diaphragm by creating a more planar diaphragm formation under high drive levels. The magnetic circuit at the outermost portion of the transducer can more effectively elevate the strongest flux lines up into the plane of the diaphragm, increasing efficiency and available drive force to the diaphragm.

In one preferred embodiment this increase in force can be at least partially derived from an increase in the flux density or “B” of the “BL” electromagnetic force at the outermost region of the mobile portion of the diaphragm, increasing excursion to create a more even, planar movement of the diaphragm by way of an additional magnetic source connected to the frame outside of the periphery of attachment of the film diaphragm and above the plane of an opposite, second surface side of the diaphragm to enhance double side magnetic energy drive force near the termination edge of the film diaphragm without any magnets in front of, the second side of the vibratable portion of the diaphragm which would interfere with the frontally projected acoustic waves of the device. The additional magnetic sources may be realized by, one or more of; a magnetically conductive pole and a magnet above the plane of the second surface side of the diaphragm or an acoustically transparent, magnetically conductive pole suspended over a second surface side of the diaphragm to increase drive to the diaphragm without any magnets suspended over the mobile portion of the second surface side of the diaphragm.

The invention provides for a wave-launch unimpeded by magnets on a second side of the vibratable portion of the diaphragm while having the advantage of an outboard magnetic circuit forward of the plane of the second surface side of the diaphragm providing a push-pull, double side drive along the outside portion of the diaphragm, or across the majority of both sides of the diaphragm, creating one or more of greater diaphragm control, more planar output and increased total output, without the drawbacks of acoustic interference of a double side drive system of the prior art. These and other forms and advantages will become apparent with the ongoing specification and claims disclosed below.

### BRIEF DESCRIPTION OF THE DRAWINGS

FIG. 1A is a cross-sectional view of a first example of the invention;

FIG. 1B shows a top plan view of the first example invention of FIG. 1A with a diaphragm thereof removed;

FIG. 2A shows the non-planar diaphragm motion resulting from the distribution force of a prior art device;

FIG. 2B shows an increase in outer diaphragm motion resulting from the distribution force of an example of the invention;

FIG. 3A shows a cross-sectional view of a prior art double-sided planar magnetic transducer;

FIG. 3B shows a cross-sectional view of a prior art single-sided planar magnetic transducer;

FIG. 3C shows the frequency response comparison of a prior art double-side driven device and an example of the invention;

FIG. 4 shows a top plan view of a second example of the invention with a diaphragm removed;

FIG. 5A shows a cross-sectional view of a third example of the invention;

FIG. 5B shows a top plan view of the third example of the invention in FIG. 5A with a diaphragm thereof removed;

FIG. 6 shows a polar plot of the dispersion of an example of the invention in FIG. 5A;

FIG. 7A shows a cross-sectional view of a fourth example of the invention;

FIG. 7B shows a plan view of the example of the invention of FIG. 7A;

FIG. 8 shows a cross-sectional view of a fifth example of the invention;

FIG. 9 shows a cross-sectional view of a sixth example of the invention;

FIG. 10 shows a cross-sectional view of a seventh example of the invention;

FIG. 11 shows a cross-sectional view of an eighth example of the invention;

FIG. 12 shows a cross-sectional view of a ninth example of the invention;

FIG. 13 shows a cross-sectional view of a tenth example of the invention;

FIG. 14 shows a cross-sectional view of an eleventh example of the invention;

FIG. 15 shows a cross-sectional view of a twelfth example of the invention;

FIG. 16 shows a cross-sectional view of a thirteenth example of the invention;

FIG. 17 shows a cross-sectional view of a fourteenth example of the invention;

FIG. 18 shows a cross-sectional view of another example of the secondary magnet structure of the invention;

FIG. 19 shows a cross-sectional view of a fifteenth example of the invention;

FIG. 20 shows a cross-sectional view of a sixteenth example of the invention with a rear chamber;

FIG. 21 shows a cross-sectional view of still another example of the secondary magnet structure of the invention;

FIG. 22 shows an cross-sectional view of an another example of the secondary magnet structure of the invention;

FIG. 23 shows a cut-away partial plan view of another example of an acoustical openings feature of the secondary magnet structure of the invention;

FIG. 24 shows a plan view of a first example of a conductive trace pattern on a diaphragm of the invention; and

FIG. 25 shows a plan view of a second example of a conductive trace pattern on a diaphragm of the invention.

### DETAILED DESCRIPTION

Referring initially to FIGS. 1A and 1B of the drawings, depicted therein is a first example of a quasi-double-sided drive, planar magnetic transducer 10a of the present invention. The first example transducer 10a comprises a frame 12, a diaphragm 14, and a primary magnetic structure 16. As depicted in FIG. 1A, a center-plane ‘A’ is defined with reference to the first example transducer 10a. A dimension of the example transducer 10a perpendicular to the center plane ‘A’ and substantially parallel to the diaphragm 14 will be referred to as a first, lateral, or width, X-axis reference direction. A direction along the center plane ‘A’ substantially perpendicular to the diaphragm will be referred to as a second, depth, or height, Y-axis reference dimension of the example transducer 10a. A dimension of the example transducer 10a parallel to the center plane ‘A’ and substantially parallel to the diaphragm 14 will be referred to as a third, longitudinal, or length, Z-axis reference direction. The magnet drawings will be represented by rectangles or squares with slanted lines, and with the primary magnets 40 being represented by lines slanting upward to the left, and secondary magnets 42, being represented by lines slanting upward to the right.

The frame 12 supports the diaphragm 14 to define a frame chamber 18. The primary magnet array 40, including three primary magnet rows 40a, 40b, and 40c, of primary magnetic structure 16, are supported within frame chamber 18 by the frame 12. In particular, the example frame 12 defines a back plate portion 22, side portions 24a and 24b extending in the depth dimension from the back plate portion 22, and flange portions 26a and 26b extending in the lateral dimension respectively from the side portions 24a and 24b. The side portions 24 and flange portions 26 thus extend around at least a portion of the frame chamber 18 as generally indicated by FIG. 1B, wherein flange portions are illustrated as 26a, 26b, 26c, and 26d.

Components of support frame 12, such as back plate 22, sidewall portions 24a, 24b, flange portions 26a, 26b may be of magnetically conductive or ferrous construction. The terms “ferrous” and “magnetically conductive” are used interchangeably in the ongoing discussions, referring to any magnetically conductive material.

As shown in FIG. 1A, a perimeter of attachment 28a defines a boundary of the vibratable portion 28b of the diaphragm 14 as it is attached to the flange portions 26a and 26b to secure the diaphragm 14 to the frame 12. In the first example transducer 10a, the entire peripheral vibratable portion 28b of the diaphragm 14 of FIG. 1A is secured to the flange portions 26a, 26b, (also flange portions 26c, and 26d shown in FIG. 1B). The vibratable portion 28b of diaphragm 14 is held in a preferred state of tension. In other words, a perimeter portion of diaphragm 14 is supported by support frame 12 such that a vibratable portion 28b of the diaphragm is held in a predetermined state of tension.

The diaphragm 14 defines a first surface 30 and a second surface 32. When supported by the frame 12 as depicted in FIG. 1A, the first surface 30 is arranged on a side of the diaphragm 14 facing the frame chamber 18 and the second surface 32 is arranged on a side of the diaphragm 14 facing away from the frame chamber 18. In the example transducer 10a, a trace 34a is formed on the second surface side 32 of the diaphragm 14 and thus is located outside of the frame chamber 18. However, the trace 34a may be formed instead or in addition on the first surface 30 of the diaphragm 14, in which case the trace 34a would be located at least partly within the frame chamber 18. As will be described in further detail below, the center primary magnet row 40a, of primary magnetic structure 16, defines a magnet surface reference plane ‘B’, and a gap 36 distance is formed between the diaphragm 14 and the reference plane ‘B’, shown as center magnet row 40a top polarity surface 60, which in magnet row 40a has the “N” (North) polarity. Outer primary magnet rows 40b and 40c may have a gap distance equal to gap 36 of center magnet row 40a gap or may in some preferred embodiments have a somewhat greater or lesser gap distance, wherein a lessor distance may offer increased efficiency and control of diaphragm 14.

The example primary magnetic structure 16 of the first example transducer device 10a comprises primary magnet row array 40. Transducer 10a of FIGS. 1A and 1B further includes two secondary magnetic structures 41a and 41b with respective secondary magnets 42a and 42b and magnetically conductive focusing pole pieces 44a and 44b. In the context of the present invention, the term “magnetically coupled” refers a dominant magnetic path or low magnetic impedance connection formed between magnets and magnetically conductive structures coupled with each other in a manner transferring magnetic energy into the magnetically conductive materials. In example 10a the primary magnets group 40, including primary magnet rows 40a, 40b, and 40c are preferably attached to, and magnetically coupled through, the back plate portion 22 by way of the back plate 22 being constructed of magnetically conductive material. As with back plate 22, sidewall portions 24 and flange portions 26 may or may not be formed of magnetically conductive material, depending on design considerations but in this example 10a of FIG. 1A, back-plate 22, sidewalls 24a and 24b and flange 26a and 26b are of magnetically conductive composition. In the example transducer 10a, the frame 12 is formed of magnetically conductive materials such that the portions 26a and 26b form passive magnetic return pole continuity from primary magnet rows 40 to secondary focusing plates 44a and 44b. The passive return pole magnetic focusing plates 44a and 44b are formed of magnetically conductive material, and are magnetically coupled to the secondary magnets 42a and 42b as indicated in FIG. 1A. Magnetic coupling may still be effective if diaphragm 14 extends beyond attachment boundary 28 and is positioned between flange 26a and focus plate 44a and also between flange 26b and focus plate 44b, as shown in FIG. 1.

In the present application, the term “return structure” will be used to refer to any structure that functions to form an enhanced magnetically conductive return path from an adjacent magnet. As examples, the back plate 22, sidewall 24, and flange 26 structures, when constructed of a magnetically conductive, or ferrous, material, may form an enhanced bi-directional return path from the primary magnet group 40 to the secondary magnetic structures 41a and 41b and thus may be referred to as a magnetic “return structure”. The passive return pole, or magnetic focusing, structures 44a, 44b may be arranged to form an enhanced return path magnetic coupling for the primary magnets 40 and the secondary magnets 42a and 42b, and thus being magnetically energized by both the primary magnet array 40 and the secondary magnet rows 42a and 42b and may also be referred to as return structures. This magnetic charging of the secondary focusing poles 44a and 44b by both the primary and secondary magnet energy provides a very strong, focused magnetic source in secondary magnetically conductive focusing plates 44a and 44b.

The term “row” refers to one or more magnets, elongated magnets, or magnetic pole structures such as the primary magnet rows 40a, 40b, and 40c in the group of primary magnets 40, and secondary magnet rows 42a and 42b of the secondary magnetic structure rows 41a and 41b, and passive return pole rows 44a and 44b, arranged on the frame structure 12 such that each magnetic structure defines at least one effective north or south magnetic pole. Each row may comprise a single magnet, elongated magnet or other structure or a plurality (two or more) of magnets, elongated magnets, or other structures, but the structures within a given row act as a unified magnetic structure.

In the first example transducer 10a, FIG. 1A defines, the magnet groups 40 and 42a, 42b are each formed by elongate, rectangular bar magnets, and the rows 40a, 40b and 40c formed by these magnets are thus straight. Similarly, the secondary magnetic structures 41a and 41b are formed to be straight and substantially parallel to primary magnet rows 40. However, bar magnets and/or flanges of other shapes may be provided, or a plurality of bar magnets may be arranged in a line or rows having shapes (e.g., curved, circular, serpentine, zigzag) other than straight.

In the first example transducer 10a, the primary magnets 40 are arranged in primary magnetic rows 40a, 40b, and 40c. The secondary magnets 42a and 42b are arranged in first and second secondary magnetic structure rows 41a and 41b. With the example frame 12, the passive return poles 44a and 44b form first and second passive return focusing pole rows directly adjacent and above the flange portions 26a and 26b and the second surface side 32 of the diaphragm 14. The first, second, and third primary rows 40a, 40b and 40c, the first and second secondary magnetic rows 42a and 42b, and the passive return focusing pole rows 44a and 44b of secondary magnetic structures 41a and 41b, are symmetrically arranged about center plane ‘A’ and generally extend along the third length or longitudinal, Z-axis dimension of the first example transducer 10a.

As illustrated in FIG. 1A, the primary magnet row 40a defines a magnetic polarity surface 60 and a magnetic polarity surface 62, and the first secondary magnet row 42a defines magnetic polarity surfaces 64a and 66a and the second secondary magnet row 42b defines magnetic polarity surfaces 64b and 66b. The magnet surface faces 60 and 62 refer to the surfaces at the “north” and “south” pole surfaces, respectively, of the primary magnet row 40a. Similarly, in FIG. 1A the magnetic polarity surfaces 64a and 66a refer to the surfaces at the “south” and “north” pole magnet surfaces, respectively, of the secondary magnet row 42a, and the magnetic polarity surfaces 64b and 66b refer to the surfaces at the “south” and “north” pole magnet surfaces, respectively, of the secondary magnet row 42b. These face numbers will be used to refer to the polarity of the surface in the ongoing discussion.

The flange portion 26b further defines a flange surface 68 that is substantially coplanar with the first surface 30 of the diaphragm 14. In the first example transducer 10a, the magnet surface faces 60 or 62 of the primary magnet row 40a in the primary magnetic row array 40 and the magnetic polarity surfaces 64 or 66 of the secondary magnets 42 in the secondary magnetic rows 42a and 42b adjacent to the diaphragm 14 are all substantially aligned with the reference plane B. Any of the magnet surfaces 60, 62, 64, or 66 adjacent to the diaphragm 14 will be referred to as an adjacent face. The first surface 30 of the diaphragm 14 is thus spaced from the adjacent face 60 defined by the primary magnet row 40a by a distance equal to that of the gap spacing 36. In some embodiments it may be preferred to have similar or somewhat lesser gap spacings between primary magnet rows 40b or 40c and the first diaphragm surface 30.

The primary magnet row 40a and secondary magnet rows 42a and 42b are formed by bar magnets polarized such that opposite poles are formed at the first (north) polarity magnetic polarity surfaces 60, 66a, 66b, and the second (south) polarity magnetic polarity surfaces 62, 64a, 64b. Further, the polarities of the primary magnets 40 in the example transducer 10a are oriented to alternate in the lateral dimension such that the north pole of the central primary magnet row 40a is adjacent diaphragm 14 and is flanked by primary magnet rows 40b and 40c with the opposite south polarity pole surface adjacent diaphragm 14. Further, the north pole of the secondary magnet rows 42a and 42b of the secondary magnetic structures 41a and 42b energize passive pole plates 26a and 26b respectively, to form effective north poles oriented and focused to the outer conductive trace portions 82a and 82b of the second surface side 32 of diaphragm 14.

The term “effective polarity” will be used in this application to refer to the energized polarity of any passive pole piece or any magnetic structure (e.g., primary magnet, secondary magnet, passive return pole portion, and/or pole structures (as discussed below)) adjacent to the diaphragm 14. The term “alternate in the lateral direction”, when used in reference to effective polarity, will be used in this application to refer to the fact that the effective polarities of a given magnet row of magnetic array 16 alternate between north and south moving in the lateral direction across the frame 12. In the first example transducer 10a, the effective polarities of the primary magnet group 40 alternate in the lateral direction from south to north to south.

The primary magnets 40 establish central unfocused magnetic fringe fields 70a and 70b. In the following discussion, the term “primary magnetic field” will refer to the magnetic fringe fields established adjacent the first surface side 30 of diaphragm 14 from primary magnet rows 40. The term “secondary magnetic field” refers to the magnetic field established above the plane of the second surface side 32 of diaphragm 14. The term “pole magnetic field” refers to a magnetic field established in a magnetically conductive magnetic pole piece from an active magnet with the passive magnetic pole piece coupled adjacent thereto, such as magnet row 42a and passive magnetically conductive magnetic pole 44a. A passive pole magnetic field may be referred to as a return magnetic field or a focused magnetic field or focused magnetic field source.

Accordingly, the physical arrangement of the primary magnets 40, the secondary magnets 42a and 42b, and the passive magnetically conductive poles 44a and 44b and the magnetic orientation of the alternating poles formed, by those structures of the first example transducer 10a described above, results in a primary magnetic fields 70a and 70b, and first and second secondary magnetic fields 72a and 72b, as shown in FIG. 1A.

Throughout the drawings the field line patterns by various alphanumerics of 70, 72 are generally illustrating the significant or stronger field lines. Magnetic fields have many lines of force, stronger and weaker, and at different angles. The most effective lines of force are those that are substantially in parallel with the plane of the diaphragm when intersecting the conductive trace patterns 34a. While stronger lines of force are shown with field lines 70 and 72, throughout the representative drawings other weaker lines of force (not shown) may also be in parallel with the diaphragm and intersecting with conductive trace patterns 34.

The field lines 72a and 72c tend to be a combination of a fringe field of the outer row primary magnet row 40b and the focused field of the nearest secondary magnetically conductive focusing plate 44a. Also, the field lines 72b and 72d tend to be a combination of a fringe field of the outer row primary magnet row 40c and the focused field of the nearest secondary magnetically conductive focusing plate 44b. The secondary focusing poles 44a and 44b tend to pull the strongest field lines upward, more in line with, and parallel to, the outer trace groups 82a and 82b respectively. This approach increases the field strengths interacting with outer trace sections 82a and 82b to increase mobilization of the outermost portions of the film diaphragm 14. This effect can be seen illustrated in FIG. 2B.

FIG. 1A further illustrates that the conductive trace 34a formed on the diaphragm 14 comprises first and second primary trace portions 80a and 80b, and first and second secondary trace portions 82a and 82b. The trace 34a is formed in a pattern such that current flowing through the trace 34a flows in the same direction within each of the three traces within each of the trace portions 80a, 80b, 82a, and 82b (also illustrated by arrow groups 94a in FIG. 24).

An electrical signal flowing through the trace 34a will thus interact with the magnetic fields 70-72 formed by the primary and secondary magnet structures and thus move relative to the magnet array 40. Because the diaphragm 14 is flexible and suspended from the frame 12, and because the trace 34a is formed on (secured to) the diaphragm 14, the diaphragm 14 also moves relative to magnet array 40 when the trace 34a moves relative to the magnet array 40. Movement of the diaphragm 14 caused by the interaction of the trace portions 80a, 80b and 82a, 82b with the magnetic fields 70a & b, and 72 a, b, c, and d, produces an acoustic output that corresponds to the electrical signal flowing through the trace 34a.

The primary magnets 40 forming the example first, second, and third primary rows 40a, 40b, and 40c preferably comprise high-energy magnets. While magnetic energy of the invention may be scaled and adapted to work with most any magnet energy density or type, the Applicant has determined that magnets having an energy product of in a first example range of at least 20 MGOe (Mega Gauss Oersteds) or in a second example range of greater than 32 MGOe are preferable for use in the primary magnet array 40. High-energy Neodymium magnets may be used in the primary magnet array 40.

The example secondary magnets 42a and 42b forming the secondary magnetic rows 41a and 41b are preferably formed of magnets having a high energy product or low energy product rating relative to that of the primary magnets 40. In particular, the secondary magnets 42a and 42b may have an MGOe energy product in a first example range at least 5 to 50 times less or in a second example range of approximately the same the MGOe energy product rating of the primary magnets 40. The example secondary magnets 42a and 42b may be magnets made of ferrite-based material for the lower energy product. The Applicant has determined that ceramic ferrite such as Ceramic 5 and Ceramic 8 and/or ferrite-impregnated rubber may be used to form the example secondary magnets 42a and 42b. Using lower energy magnets in the secondary magnet structures may increase the stability of the outer portions of the diaphragm while keeping costs lower. The secondary magnets may alternatively be made of a magnet material the same as that of the primary magnet array 40, with similar energy density, or somewhat lower or greater energy density. In all cases, the inventive arrangement of the secondary magnets may provide a greater magnetic force or may provide a better positioning of the lines of magnetic force, as a novel double sided drive, while keeping a primary acoustic path direction 8, into an external environment, unimpeded by magnets adjacent the second surface side 32 of diaphragm 14, as compared to prior art double sided drive devices shown in FIG. 3A. The term “environment external to the transducer” or “external environment” may be a listening room, or an entrance into an acoustic horn or waveguide, or any other environment into which the device may be used to transmit acoustic energy based on an electrical input signal.

The secondary magnetically conductive plates 44a and 44b and flanges 26a and 26b may operate as enhanced return poles forming part of the magnetic return path through the back plate portion 22 from the primary magnet rows 40b and 40c. Secondary magnets 42a and 42b provide increased magnetic energy into the magnetic magnetically conductive poles 44a and 44b and return flange poles 26a and 26b. Both of these magnetic energy paths, from primary magnets and secondary magnets, converging in the same magnetic polarity to magnetically energize magnetic poles 44a and 44b and return flange poles 26a and 26b, increase the focused magnetic energy in magnetic fields 72a and 72b and therefore maximizing magnetic flux in conductive traces 82a and 82b. This arrangement also elevates field 72a and 72b to optimize positioning of magnetic energy and to maximize energy in the plane of the traces 82a and 82b.

The improved vertical positioning of, and increased energy delivered to, magnetic fields 72a and 72b by the inventive magnetic structure can provide a number of advantages, such as increased control and reduced distortion in the outermost mobile diaphragm portions near the attachment area of flange surface 26a and 26b. This can be achieved with high-energy secondary magnets 42a and 42b or low cost, lower-energy secondary magnets 42a and 42b with MGO ratings as specified above, reducing total magnetic cost for a given transducer output and reduced distortion. Alternatively, with high-energy secondary magnets in positions 42a and 42b, the transducer 10a of FIG. 1A may achieve greater planar drive across the diaphragm 14 increasing output at the outer portions 101c and 101d of the diaphragm 14 as shown in the comparison of the deflection of the diaphragm of prior art devices represented in FIG. 2A and that of the invention represented in FIG. 2B. FIG. 2A shows diaphragm 4 of a prior art planar magnetic device with prior art drive applied to diaphragm 4. It can be seen that this causes the diaphragm to have tympanic displacement of greater mobility in the center of total diaphragm mobility 104 than at the outer edges 101a and 101b of the diaphragm 4. With the invention shown in FIG. 1A diaphragm displacements can be formed more like that shown in FIG. 2B, with a more planar shape with the displacements at outer portions 101c and 101d of diaphragm 14 more effectively approaching the magnitude of the center of total mobility 114 of diaphragm 14. This effect may be increased by increasing the ratio of the magnetic force applied to outer conductive traces 82a and 82b, as compared to the magnetic force applied to central conductive traces 80a and 80b. This increase may be realized by using magnets 42a, 42b of greater magnetic force in the secondary magnet structures 41a and 41b or optimizing the shape and positioning of focusing poles 44a and 44b for maximum magnetic energy in the plane of outer conductive trace groups 82a and 82b. Increasing the diaphragm deflection at the outer edges to create a more planar formation can increase the cubic volume displacement and therefore increase the acoustical output with the application of secondary magnetic structures 41a and 41b of the planar magnetic transducer of FIG. 1A for a given electrical power input. Alternatively, reducing magnetic energy in central magnet row 40a or all of the primary magnet rows 40 may increase the effect.

Referring to FIGS. 1A and 1B, acoustic openings 90 may optionally be formed in the back plate portion 22 of the frame 12 to reduce air-load stiffness on the diaphragm 14 that would otherwise restrict movement of the diaphragm 14 at lower frequencies. These openings may not be required for ‘tweeter’ versions of the invention, with higher range operating frequencies, but for wider range devices operating to lower frequencies, the openings may be preferred. Also, they can allow the device to be operated as an acoustic dipole, with sound emanating from the front and back of the device, in opposite acoustic polarity. Acoustic resistance material 91, shown in FIG. 1B, may also be optionally arranged within the frame chamber 18 to at least partly cover the openings 90 and thereby damp high “Q” resonances of the diaphragm. If used, the acoustic resonance material 91 can be placed anywhere from inside the frame chamber 18 to being placed external to transducer 10a, behind back-plate 22 of frame 12. The acoustical resistance material 91 can be any acoustically resistive material such as porous acoustical open or closed cell foam, felt, woven materials, cloth, fiberglass, or other materials known for resistive damping of acoustical energy.

At the fundamental resonant frequency of the diaphragm 14 of transducer 10a in many of the embodiments, the ‘Q’ of the resonance can be quite high, with values greater than two and an associated amplitude peak of greater than 6 dB at the resonant frequency. The damping material 91 can be used to damp the peak down to a ‘Q’ of one or less and create a substantially flat amplitude response through the resonant frequency range. The damping can also be used to smooth and damp upper frequency resonances that may be generated in the diaphragm 14. This material can be deployed with greater or lesser density or in greater or lesser amounts or deleted, depending on the desired amount of damping for a particular device.

Turning now more specifically to FIG. 1B of the drawing, that figure shows a top plan view of the first example transducer device 10a with film diaphragm 14 removed for clarity. In FIG. 1B, the acoustic resistance material 91 is shown, for clarity, as only partially covering thru-hole the openings 90 in magnetically conductive back plate portion 22. The acoustic material may be placed in the frame chamber 18, against back-plate 22, or moved forward closer to the diaphragm 14, or may fill the majority of the frame chamber 18. Alternatively, the acoustic material may be placed outside of frame chamber 18, on the outside of back-plate 22, as shown in FIG. 18. Further shown is support frame 12, including primary magnetic structure 16, supporting primary magnet array 40, consisting of elongated primary magnet rows 40a, 40b, and 40c. Flanges 26a, 26b, 26c, and 26d are part of support frame 12, with flanges 26a and 26b supporting secondary magnetic structures 41a and 41b, each including magnetic focusing poles 44a and 44b, and secondary magnets 42a and 42b, respectively.

The inventive double-sided drive planar magnetic transducer with acoustically transparent main output side of FIGS. 1A and 1B provides a number of advantages over the prior art, including acoustic transparency in primary acoustic output direction 8a that is superior to prior art double sided planar magnetic transducers 1a of FIG. 3A that have solid magnets 3d, 3e, and 3f and cavities 7b adjacent both sides of the diaphragm 4 which disrupt the primary acoustical output 8, as illustrated graphically by curve 102a in FIG. 3C. Additionally, the double-sided drive inventive transducer of FIG. 1A and FIG. 1B provides greater output than the singled-end drive prior art device of FIG. 3B while maintaining the uninterrupted output in primary acoustic output direction 8 of prior art device of FIG. 3B as shown graphically in curve 108b of FIG. 3C. Besides offering the above stated improvements over the prior art doubled ended drive and single-ended drive transducers, implementations of the first example 10a of the invention may also provide further advantage over prior art planar magnetic transducers with superior planar formation of the diaphragm 14, as shown by increased diaphragm edge mobility 101c and 101d and total diaphragm mobility 114, in FIG. 2B due to increased magnetic field force on outer conductive trace groups 82a and 82b, of FIG. 1A.

FIG. 3A illustrates a prior art double-sided (or sometimes referred to as double-ended) drive, planar magnetic transducer 1a comprising; a back plate 2a and front plate 2b supporting the three back rows of magnets 3a, 3b, and 3c and three front rows of magnets 3d, 3e, and 3f, thin film diaphragm 4 and conductive traces 5 attached to diaphragm 4. Upon the movement of diaphragm 4, acoustic output is produced and projected into cavities 7a, and 7b, and through openings 6a in back plate 2a and openings 6c in front plate 2b and in a primary acoustic path direction 8 into an external environment. Also, shown are the maximum magnetic energy magnetic field lines 9a and 9b at one lateral side of the transducer (equivalent fields would exist at the opposite lateral side of the transducer). It can be seen that they fall below the outer conductive trace 5b and therefore make less contribution to driving the outer edges of the diaphragm 4.

FIG. 3B illustrates a prior art single-sided drive (or sometimes referred to as single-ended), planar magnetic transducer 1b comprising; a back plate 2a supporting the back rows of magnets 3a, 3b, and 3c, thin film diaphragm 4 and conductive traces 5 attached to diaphragm 4. Upon the movement of diaphragm 4, acoustic energy is produced and projected into cavities 7a, and through openings 6 in back plate 2 and ‘directly’ out in a primary acoustic path direction 8 into an external environment.

While the single-ended transducer 1b of FIG. 3B has less magnetic energy and efficiency than the double-ended device 1a of FIG. 3A, the single ended device of FIG. 3B emits acoustic energy ‘directly’ off the diaphragm in a primary acoustic path direction 8 into an external environment, unimpeded by physical magnets, whereas the primary acoustic path direction output 8 of double-ended device of FIG. 3B is impeded by magnets 3a, 3b, 3c and cavities 7b, which can cause resonances and amplitude distortions to the acoustic output (shown in frequency response curve 102a of FIG. 3C).

Both of the prior art devices of FIGS. 3A and 3B also exhibit low magnetic energy and poor positioning of the strongest lines of force 9 (9a, 9b in FIG. 3A) near the edge of the diaphragm 4, causing inefficient drive force to the outer conductive traces 5b on diaphragm 4.

In FIG. 3C illustrates an advantage of the invention as compared to the prior art. Frequency response curve 102a shows the resulting response anomalies of the prior art, such as FIG. 3A double sided, (or double-ended), planar magnetic transducer 1a with magnet rows 3a, 3b, 3c and 3d, 3e, 3f, adjacent both surface sides of a planar magnetic transducer diaphragm 4 including conductive trace pattern 5a. Referring to FIG. 3A, any magnets such as 3d, 3e and 3f, located over the central or mobile portion of the primary listening side 8, of the diaphragm 4 can disrupt the high frequency response of the transducer, as illustrated in curve 102a of FIG. 3C. Frequency response curve 102b of FIG. 3C shows the present invention having smoother and more extended high frequency response, due to not having any magnets in front of the listening side of the diaphragm. The invention is able to achieve this improvement in response, compared to double-sided devices, with increased output capability comparable to double ended devices, due to the secondary magnets 42a and 42b (in FIG. 1A) being positioned outside of the vibratable portion 28b of diaphragm 14 while magnetically energizing the diaphragm also from the second surface side 32 of diaphragm 14 without having any blockage or interference from magnets in front of the second surface side 32 of diaphragm 14.

FIG. 4 shows a second example of the invention with a top plan view of the transducer device 10b with film diaphragm 14 removed for clarity. FIG. 4 is similar to the example 10a of FIG. 1B, but in addition to first and second secondary magnetic structures 41a and 41b, with secondary magnet rows 42a and 42b and magnetically conductive pole plates 44a and 44b of FIG. 1B, additional secondary magnetic structure 41c, 41d, and 41e including magnets 42c, 42d, and 42e, mounted to and magnetically energizing passive magnetically conductive focusing poles 44c, 44d, and 44e mounted to each longitudinal end of frame 12 on flanges 26c and 26d. These additional secondary magnetic structures provide increased output at each end of the transducer in substantially the same manner as first and second secondary magnetic structures of FIG. 1B the additional magnetics at each end provide additional enhancements to transducer 10b output, improving diaphragm control, planar diaphragm drive and increased total output and efficiency by energizing normally undriven end run trace groups, 96a and 96b, shown on example diaphragm 14 of FIG. 24.

Referring to FIG. 5A and FIG. 5B, shown is a third example of the planar-magnetic transducer invention 10c for generating an acoustic output based on an electrical signal. FIG. 5B shows the third example 10c of the invention with a top plan view of the transducer device 10c with film diaphragm 14 removed for clarity. Transducer 10c is comprised of support frame 12, and diaphragm 14, including first surface side 30, second surface side 32, and perimeter of attachment 28a attached to the support frame 12. The perimeter of attachment 28a encompasses the vibratable portion 28b of the diaphragm 14 and the vibratable portion 28b of the diaphragm 14 is held in a predetermined state of tension. In other words, a perimeter portion of diaphragm 14 is supported by support frame 12 such that a vibratable portion 28b of the diaphragm is held in a predetermined state of tension.

A conductive trace pattern 34a is formed on the diaphragm 14 and arranged to receive an electrical input signal. Conductive trace pattern 34a has first and second outermost lateral edges defining a driven portion 34b of the diaphragm 14. Primary magnetic structure 16 includes the group of three elongated primary magnet rows 40 coupled to back-plate 22 of the support frame 12.

The elongated primary magnet rows 40a, 40b, and 40c are primarily operable as sources of magnetic fringe fields, 70a, 70b, interacting with the conductive trace pattern 34a, including conductive trace sections 80 and 82a and 82b. The primary magnet rows 40 are positioned adjacent to, and spaced a predetermined gap distance 36 from, the first surface side 30 of the diaphragm 14.

A secondary magnetic structure 41a is positioned on the same lateral side of center plane “A” of transducer 10c as flange 26a and is mounted on flange 25a. The secondary magnetic structure 41a includes a magnetically conductive focusing pole 44a, which is attached to a North-pole magnetic polarity surface 66a of the secondary magnet 42a. The secondary magnetic structure 41a is mounted to flange 26 of support frame 12 and positioned above a plane of the second surface side 32 of the diaphragm 14 with the secondary magnet 42a positioned laterally outside the lateral boundary of the driven portion 34b of diaphragm 14 and in this example of the invention, outside of the vibratable portion 28b of the diaphragm 14. The magnetic field lines represented by 72c are strengthened and elevated closer to the plane of the diaphragm by the secondary magnetic structure 41a. The magnetic field line 72d is not augmented by a secondary magnetic structure and therefore the stronger lines of magnetic force tend to form below the plane of the diaphragm 14 and outer conductive trace group 82b, with conductive trace group 82b being driven less than conductive trace group 82a. The secondary magnetic structure 41a is primarily operable as a focused magnetic source of field 72a which interacts with at least a portion of the outer conductive trace group 82a of the elongated conductive trace pattern 34a, wherein the electrical signal is applied to the conductive trace pattern 34a such that the primary magnet rows 40 generating fringe fields 70a, 70b, and the secondary magnetic structure 41a generating focused field 72a, cause movement of the conductive trace pattern 34a and the diaphragm 14, thereby generating the acoustic output.

The mobility of the diaphragm 14, and the acoustic output, of transducer 10c, is skewed to one side as compared to the example of FIGS. 1A and 1B, due to secondary magnet structure, 41b of FIG. 1A being removed, leaving only secondary magnetic structure 41a in the device of FIG. 5A. This example of the invention provides similar performance advantages as the example in FIG. 1A, but with the additional attribute of increased drive to trace group portion 82a relative to that of trace group 82b of conductive trace pattern 34a on diaphragm 14, biasing the drive force more so in one lateral direction. This offers an additional benefit for applications where asymmetrical dispersion in one direction may be advantageous, such as left and right stereo pairs of loudspeakers or other applications where asymmetrical directivity is useful.

The dispersion graph of FIG. 6 shows the (dotted line) dispersion 103 of the symmetrical device of FIG. 1A and an example of increased asymmetrical lateral (solid line) dispersion 106 of the asymmetrical transducer 10c of FIGS. 5A and 5B.

FIG. 7A and FIG. 7B show a fourth example 10d of the invention, similar to that of FIG. 1A, 1B, but with secondary extended magnetically conductive focusing pole pieces 45a and 45b connected to magnetic polarity surfaces 64a and 64b of secondary magnets 42a and 42b of secondary magnetic structures 41a and 41b and extending over diaphragm 14. FIG. 7B shows the fourth example 10d of the invention with a top plan view of the transducer device 10d with film diaphragm 14 removed for clarity. For the purposes of description clarity, some component numbering will be referred to the drawings in FIGS. 1A and 1B. The fourth example of the planar-magnetic transducer invention 10d for generating an acoustic output based on an electrical signal, is comprised of a support frame 12, diaphragm 14, including first surface side 30 (as shown numbered in FIG. 1A), second surface side 32 (as shown numbered in FIG. 1A), and perimeter of attachment 28a (as shown numbered in FIG. 1A) attached to the support frame 12. The perimeter of attachment 28a encompasses the vibratable portion 28b of the diaphragm 14 and the vibratable portion 28b of the diaphragm 14 is held in a predetermined state of tension. In other words, a perimeter portion of diaphragm 14 is supported by support frame 12 such that a vibratable portion 28b of the diaphragm is held in a predetermined state of tension.

A conductive trace pattern 34a is formed on the diaphragm 14 and arranged to receive an electrical input signal. Conductive trace pattern 34a distributed across the diaphragm has first and second outermost lateral edges of trace group 82a and 82b defining a driven portion 34b of the diaphragm 14. Primary magnetic structure 16 includes the group of three elongated primary magnet rows 40 coupled to back-plate 22 of the support frame 12.

The elongated primary magnet rows 40a, 40b, and 40c are primarily operable as sources of magnetic fringe fields 70a, 70b interacting with the conductive trace pattern 34a. The primary magnet rows are positioned adjacent to, and spaced a predetermined gap distance 36 from, the first surface side 30 of the diaphragm 14. First and second secondary magnetic structures 41a and 41b are coupled to flanges 26a and 26b respectively. The secondary magnetic structures 41a and 41b, include magnetically conductive focusing poles 44a and 44b, to which the North-pole magnetic polarity surface 66a of the secondary magnet 42a and the North-pole magnetic polarity surface 66b of the secondary magnet 42b are respectively attached. The secondary magnetic structures 41a and 41b are coupled to flanges 26a and 26b of support frame 12 and are positioned above a plane of the second surface side 32 of the diaphragm 14 with the secondary magnets 42a and 42b positioned laterally outside of the vibratable portion 28b of the diaphragm 14. The focusing poles 44a and 44b, of secondary magnetic structures 41a and 41b, are primarily operable as focused magnetic sources which combine with the magnetic fringe fields from primary magnet rows 40b and 40c to generate maximum field lines 72a and 72b respectively, which interact with at least portions of the elongated trace groups 82a and 82b of the conductive trace pattern 34a, wherein an electrical audio signal is applied to the conductive trace pattern 34a such that the primary magnet row group 40 create fringe field lines 70 and the focusing poles 44a and 44b of the secondary magnetic structure 41a and 41b create combine with primary magnet rows 40b and 40c to create focused field lines 72a and 72b to cause movement of the conductive trace pattern 34a and the diaphragm 14, thereby generating an acoustic output.

The secondary magnetic structure 41a includes a secondary extended magnetically conductive focusing pole 45a extending over a portion of the second surface side 32 (as numbered in FIG. 1A) of the diaphragm 14, with a magnetically focused termination face 48a spaced away from the second surface side 32 of the diaphragm 14 by secondary extended focusing pole gap distance 52a which is a similar or equal distance as primary magnet row 40b is spaced away from the first surface side 30 (as numbered in FIG. 1A) by distance gap 36 of diaphragm 14 and secondary magnetic structure 41a magnetically focused termination face 48a is positioned directly across from primary magnet row 40b.

Also, the secondary magnetic structure 41b includes a second secondary extended magnetically conductive focusing pole 45b extending over a portion of the second surface side 32 (as numbered in FIG. 1A) of the diaphragm 14, with a magnetically focused termination face 48b spaced away from the second surface side 32 of the diaphragm 14 by a similar or equal distance as primary magnet row 40c is spaced away from the first surface side 30 (as numbered in FIG. 1A) of diaphragm 14 and secondary magnetic structure 41b magnetically focused termination face 48b is positioned directly across from primary magnet row 40b.

The magnetically conductive focusing pole termination face 48a extending over a portion of the second surface side 32 of the diaphragm 14 and spaced by secondary extended focusing pole gap distance 52b has a South polarity and the focusing pole termination face 48a is positioned adjacent primary magnet row 40b that has a same South magnetic polarity as the focusing pole termination face 48a.

The magnetically conductive focusing pole termination face 48b extending over a portion of the second surface side 32 of the diaphragm 14 has a South polarity and the focusing pole termination face 48b is positioned adjacent primary magnet row 40c that has a same South magnetic polarity as the focusing pole termination face 48b. The secondary extended magnetically conductive focusing pole 45a is attached to a secondary magnetic polarity surface 64a farthest from a plane of the diaphragm 14, and the secondary magnetic structure 41a secondary extended magnetically conductive focusing pole 45a includes openings 92a to increase the acoustical transparency of the secondary extended magnetically conductive focusing pole 45a.

The second secondary extended magnetically conductive focusing pole 45b is attached to a secondary magnetic polarity surface 64b farthest from a plane of the diaphragm 14, and the secondary magnetic structure 41b second secondary extended magnetically conductive focusing pole 45b includes openings 92b to increase the acoustical transparency of the second secondary extended magnetically conductive focusing pole 45b.

The FIG. 7A, fourth example 10d of the invention, is similar to that of FIG. 1A, 1B, with secondary extended magnetically conductive focusing pole pieces 45a and 45b connected to magnetic polarity surfaces 64a and 64b of secondary magnets 42a and 42b of secondary magnetic structures 41a and 41b. In this example transducer 10d, the magnetic polarity surfaces 64a and 64b are both “South” polarity surfaces. Theses magnetic pole focusing structures are configured with openings 92a and 92b to maintain acoustical transparency. These openings provide acoustic transparency in primary acoustic output direction 8a that is superior to prior art double sided planar magnetic transducers 1a of FIG. 3A that have solid magnets 3d, 3e, and 3f and cavities 7b adjacent both sides of the diaphragm 4 which disrupt the primary acoustical output 8, as illustrated graphically by curve 102a in FIG. 3C. In this example 10d, the additional secondary magnetic poles arch over the outermost primary magnet rows 40b and 40c to create the same polarity adjacent both surface sides of diaphragm 14, increasing the efficiency of transducer 10d while maintaining substantial acoustical transparency through secondary extended magnetically conductive focusing pole 45a and 45b which allows the high frequencies to be smooth and extended, as shown in response 102b of the graph of FIG. 3C. The example of FIGS. 7A and 7B can provide even more magnetic efficiency than the example transducer of FIGS. 1A and 1B, while maintaining smooth high frequency response in primary acoustical direction 8.

FIG. 8 shows a fifth example 10e of the invention, similar to that of FIG. 7A, but with the primary magnetic structure 16 comprising one magnet row 40a. The fifth example of the planar-magnetic transducer invention 10e for generating an acoustic output based on an electrical signal, is comprised of a support frame 12, diaphragm 14, including first surface side 30, second surface side 32, and perimeter of attachment 28a attached to the support frame 12. The perimeter of attachment 28a encompasses the vibratable portion 28b of the diaphragm 14 and the vibratable portion 28b of the diaphragm 14 is held in a predetermined state of tension. In other words, a perimeter portion of diaphragm 14 is supported by support frame 12 such that a vibratable portion 28b of the diaphragm is held in a predetermined state of tension.

A conductive trace pattern 34a is formed on the diaphragm 14 and arranged to receive an electrical input signal. Conductive trace pattern 34a distributed across the diaphragm has first and second outermost lateral edges defining a driven portion 34b of the diaphragm 14. Primary magnetic structure 16 includes the primary magnet row 40a coupled to back-plate 22 of the support frame 12. The elongated primary magnet row 40a is primarily operable as a source of magnetic fringe fields interacting with the conductive trace pattern 34a. The magnet row 40a is positioned adjacent to, and spaced a predetermined gap distance 36 from, the first surface side 30 of the diaphragm 14.

First and second secondary magnetic structures 41a and 41b are coupled to flanges 26a and 26b respectively. The secondary magnetic structures 41a and 41b, include magnetically conductive focusing poles 44a and 44b, to which the South-pole magnetic polarity surface 66a of the secondary magnet 42a and the South-pole magnetic polarity surface 66b of the secondary magnet 42b are respectively attached. The secondary magnetic structures 41a and 41b are coupled to flanges 26a and 26b of support frame 12 and are positioned above a plane of the second surface side 32 of the diaphragm 14 with the secondary magnets 42a and 42b positioned, laterally outside the lateral boundary of the driven portion 34b of diaphragm 14 and in this example of the invention, laterally outside of the vibratable portion 28b of the diaphragm 14. The focusing poles 44a and 44b, of secondary magnetic structures 41a and 41b, are primarily operable as focused magnetic sources which combine with the magnetic fringe fields from primary magnet row 40a to maximum magnetic energy which interacting with at least portions of the conductive trace pattern 34a.

The secondary magnetic structure 41a includes a secondary extended magnetically conductive focusing pole 45a extending over a portion of the second surface side 32 of the diaphragm 14, with a magnetically focused termination face 48 spaced away from the second surface side 32 of the diaphragm 14 with a secondary extended focusing pole gap distance 52 by a similar or equal distance as primary magnet row 40b is spaced away by gap 36 from the first surface side 30 of diaphragm 14 and secondary magnetic structure 41a magnetically focused termination face 48 is positioned directly across from primary magnet row 40a.

Also, the secondary magnetic structure 41b includes a second secondary extended magnetically conductive focusing pole 45b extending over a portion of the second surface side 32 of the diaphragm 14, with a magnetically focused termination face 48 spaced away from the second surface side 32 of the diaphragm 14 by a similar or equal distance as primary magnet row 40a is spaced away from the first surface side 30 of diaphragm 14 and secondary magnetic structure 41b magnetically focused termination face 48 is positioned directly across from primary magnet row 40a. In this example of the inventive transducer secondary extended magnetically conductive focusing poles 45a and 45b merge into a single magnetically focused termination face 48.

The magnetically conductive focusing pole termination face 48 extending over the central portion of the second surface side 32 of the diaphragm 14 has a North polarity and the focusing pole termination face 48 is positioned adjacent primary magnet row 40a that has a same North magnetic polarity as the focusing pole termination face 48.

The secondary extended magnetically conductive focusing pole 45a is attached to a secondary magnetic polarity surface 64a farthest from a plane of the second surface side 32 of diaphragm 14, and the secondary magnetic structure 41a secondary extended magnetically conductive focusing pole 45a includes openings 92a to increase the acoustical transparency of the secondary extended magnetically conductive focusing pole 45a in the primary acoustic output direction 8a. The second secondary extended magnetically conductive focusing pole 45b is attached to a secondary magnetic polarity surface 64b farthest from a plane of the second surface side 32 of diaphragm 14, and the secondary magnetic structure 41b secondary extended magnetically conductive focusing pole 45b includes openings 92b to increase the acoustical transparency of the second secondary extended magnetically conductive focusing pole 45b.

The FIG. 8 fifth example the invention with transducer 10e with secondary magnetic structures 41a and 41b including secondary extended magnetically conductive focusing poles 45a and 45b either closely spaced or summed as one piece to form a magnetic polarity face 48 adjacent diaphragm 14 that matches the magnetic polarity of magnet row 40a that is also adjacent diaphragm 14 on the opposite surface side, in this example, both having a polarity of ‘N’ or North. In this example of the invention, the magnetic energy can be configured with substantial symmetrical on both sides of the diaphragm, providing a double ended, push-pull planar magnetic transducer, but due to no actual magnets blocking the acoustical output of the diaphragm adjacent the surface side that secondary extended magnetically conductive focusing poles 45a and 45b reside, secondary extended magnetically conductive focusing poles 45a and 45b can be made substantially acoustically transparent with openings 92a and 92b such that the acoustic output in the primary acoustic output direction 8a is substantially unimpeded by the secondary extended magnetically conductive focusing pole pieces 45a and 45b.

FIG. 9 shows a sixth example of the invention with transducer 10f that is similar in architecture to the example of FIG. 8, but with the primary magnet row 40a of FIG. 8 rotated 90-degrees such that the magnet row 47a of FIG. 9 polarities are arranged laterally, parallel to the back plate 22a. Because both polarities are in contact with back plate 22a it is essential that back plate portion coupled to magnet row 47a is made from non-magnetically-conductive material, so as not to short out the magnetic energy of primary magnet 47a. This arrangement, with the lateral polarities operates similar to having two primary magnets of North and South poles oriented to be adjacent to the diaphragm. Due to the primary magnet having opposite lateral polarities, the secondary magnet structures 41a and 41b are also of opposite polarities in relation to each other so that the secondary extended magnetically conductive focusing pole 45a with a ‘North’ polarity termination surface 48a positioned adjacent the North polarity portion of the primary magnet 47a and second secondary extended magnetically conductive focusing pole 45b, with a ‘South’ polarity termination surface 48b, positioned adjacent the ‘South’ polarity portion of primary magnet 47a.

The FIG. 9, sixth example of the planar-magnetic transducer invention 10f for generating an acoustic output based on an electrical signal, is comprised of a support frame 12, diaphragm 14, including first surface side 30, second surface side 32, and perimeter of attachment 28a attached to the support frame 12. The perimeter of attachment 28a encompasses the vibratable portion 28b of the diaphragm 14 and the vibratable portion 28b of the diaphragm 14 is held in a predetermined state of tension. In other words, a perimeter portion of diaphragm 14 is supported by support frame 12 such that a vibratable portion 28b of the diaphragm is held in a predetermined state of tension.

A conductive trace pattern 34a is formed on the diaphragm 14 and arranged to receive an electrical input signal. Conductive trace pattern 34a distributed across the diaphragm has first and second outermost lateral edges defining a driven portion 34b of the diaphragm 14. Primary magnetic structure 16 includes the primary magnet row 47a coupled to non-magnetically conductive back-plate 22a of the support frame 12.

The elongated primary magnet row 47a is primarily operable as a source of a magnetic fringe field interacting with the conductive trace pattern 34a. The magnet row 47a is positioned adjacent to, and spaced a predetermined gap distance 36 from, the first surface side 30 of the diaphragm 14.

The first secondary magnetic structure 41a is coupled to flange 26a. The secondary magnetic structure 41a includes magnetically conductive focusing pole 44a, to which the South-pole magnetic polarity surface 66a of the secondary magnet 42a is attached. The second secondary magnetic structure 41b is coupled to flange 26b. The secondary magnetic structure 41b includes magnetically conductive focusing pole 44b, to which the North-pole magnetic polarity surface 66b of the secondary magnet 42b is attached. The secondary magnetic structures 41a and 41b that are coupled to flanges 26a and 26b of support frame 12 are positioned above a plane of the second surface side 32 of the diaphragm 14 with the secondary magnets 42a and 42b positioned, laterally outside of the vibratable portion 28b of the diaphragm 14. The focusing poles 44a and 44b, of secondary magnetic structures 41a and 41b, are primarily operable as focused magnetic sources interacting with at least portions of the conductive trace pattern 34a.

The secondary magnetic structure 41a includes a secondary extended magnetically conductive focusing pole 45a extending over a portion of the second surface side 32 of the diaphragm 14 and over a portion of conductive trace pattern 34a, with a magnetically focused North polarity termination surface 48a spaced away from the second surface side 32 of the diaphragm 14 by secondary extended focusing pole gap distance 52a which is a similar or equal distance as primary magnet row 47a is spaced away from the first surface side 30 of diaphragm 14 by distance gap 36, and secondary magnetic structure 41a magnetically focused termination surface 48a with a North magnetic polarity is positioned directly across from the North polarity portion of primary magnet row 47a.

Similarly, the secondary magnetic structure 41b includes a second secondary extended magnetically conductive focusing pole 45b extending over a portion of the second surface side 32 of the diaphragm 14 and over a portion of conductive trace pattern 34a, with a magnetically focused South polarity termination surface 48b spaced away from the second surface side 32 of the diaphragm 14 by secondary extended focusing pole gap distance 52b which is a similar or equal distance as primary magnet row 47a is spaced away from the first surface side 30 of diaphragm 14 by distance gap 36 and secondary magnetic structure 41b magnetically focused South polarity termination surface 48b is positioned directly across from the South polarity portion of primary magnet row 47a. The secondary extended magnetically conductive focusing pole 45a is attached to a secondary magnetic polarity surface 64a farthest from a plane of the second surface side 32 of diaphragm 14, and the secondary magnetic structure 41a secondary extended magnetically conductive focusing pole 45a includes openings 92a to increase the acoustical transparency of the secondary extended magnetically conductive focusing pole 45a in the primary acoustic output direction 8a. The second secondary extended magnetically conductive focusing pole 45b is attached to a secondary magnetic polarity surface 64b farthest from a plane of the second surface side 32 of diaphragm 14, and the secondary magnetic structure 41b second secondary extended magnetically conductive focusing pole 45b includes openings 92b to increase the acoustical transparency of the second secondary extended magnetically conductive focusing pole 45b to increase the acoustical transparency of the secondary extended magnetically conductive focusing pole 45b in the primary acoustic output direction 8a.

In this example of the invention, the magnetic energy can achieve increased symmetry on both sides of the diaphragm, producing increased efficiency of a double ended, push-pull planar magnetic transducer, but due to no actual magnets blocking the acoustical output of the diaphragm adjacent the surface side that secondary extended magnetically conductive focusing poles 45a and 45b reside, secondary extended magnetically conductive focusing pole 45a and 45b can be made substantially acoustically transparent with openings 92a and 92b such that the acoustic output in the primary acoustic output direction 8a is substantially unimpeded by the secondary extended magnetically conductive focusing poles 45a and 45b.

FIG. 10 shows a seventh example 10g of the invention, similar to that of FIG. 9, but with the primary magnetic structure 16 comprising two magnet rows 40b and 40c. The Seventh example of the planar-magnetic transducer invention 10g for generating an acoustic output based on an electrical signal, is comprised of a support frame 12, diaphragm 14, including first surface side 30, second surface side 32, and perimeter of attachment 28a attached to the support frame 12. The perimeter of attachment 28a encompasses the vibratable portion 28b of the diaphragm 14 and the vibratable portion 28b of the diaphragm 14 is held in a predetermined state of tension. In other words, a perimeter portion of diaphragm 14 is supported by support frame 12 such that a vibratable portion 28b of the diaphragm is held in a predetermined state of tension.

A conductive trace pattern 34a is formed on the diaphragm 14 and arranged to receive an electrical input signal. Conductive trace pattern 34a distributed across the diaphragm has first and second outermost lateral edges defining a driven portion 34b of the diaphragm 14. Primary magnetic structure 16 includes primary magnet array 40, including the primary magnet rows 40b and 40c coupled to, preferably magnetically conductive, back-plate 22 of the support frame 12. The elongated primary magnet rows 40b and 40c are primarily operable as a source of magnetic fringe fields interacting with the conductive trace pattern 34a. The magnet rows 40b and 40c are positioned adjacent to, and spaced a predetermined gap distance 36 from, the first surface side 30 of the diaphragm 14.

The first secondary magnetic structure 41a is coupled to flange 26a. The secondary magnetic structure 41a includes magnetically conductive focusing pole 44a, to which the South-pole magnetic polarity surface 66a of the secondary magnet 42a is attached. The second secondary magnetic structure 41b is coupled to flange 26b. The secondary magnetic structure 41b includes magnetically conductive focusing pole 44b, to which the North-pole magnetic polarity surface 66b of the secondary magnet 42b is attached. The secondary magnetic structures 41a and 41b are coupled to flanges 26a and 26b of support frame 12 and are positioned above a plane of the second surface side 32 of the diaphragm 14 with the secondary magnets 42a and 42b positioned, laterally outside the lateral boundary of the driven portion 34b of diaphragm 14 and in this example of the invention, laterally outside of the vibratable portion 28b of the diaphragm 14. The focusing poles 44a and 44b, of secondary magnetic structures 41a and 41 b, are primarily operable as focused magnetic sources which combine with the magnetic fringe fields from primary magnet rows 40b and 40c to maximum magnetic energy which interacting with at least portions of the conductive trace pattern 34a.

The secondary magnetic structure 41a includes a secondary extended magnetically conductive focusing pole 45a extending over a portion of the second surface side 32 of the diaphragm 14, with a polarity termination surface 48a spaced away from the second surface side 32 of the diaphragm 14 by secondary extended focusing pole gap distance 52a, which is a similar or equal distance as primary magnet row 40b is spaced away from the first surface side 30 of diaphragm 14 by distance gap 36 and secondary magnetic structure 41a magnetically focused termination surface 48a is positioned directly across from primary magnet row 40b.

Also, the secondary magnetic structure 41b includes a second secondary extended magnetically conductive focusing pole 45b extending over a portion of the second surface side 32 of the diaphragm 14, with a polarity termination surface 48b spaced away from the second surface side 32 of the diaphragm 14 by a secondary extended focusing pole gap distance 52b, a similar or equal distance as primary magnet row 40c is spaced away from the first surface side 30 of diaphragm 14 by distance gap 36, and secondary magnetic structure 41b polarity termination surface 48b is positioned directly across from primary magnet row 40c.

The polarity termination surface 48a extending over the second surface side 32 of the diaphragm 14 has a “North” magnetic polarity and the polarity termination surface 48a is positioned across from primary magnet row 40b that has a same “North” magnetic polarity as the polarity termination surface 48a.

The polarity termination surface 48b extending over the second surface side 32 of the diaphragm 14 has a “South” magnetic polarity and the polarity termination surface 48b is positioned across from primary magnet row 40c that has a same “South” magnetic polarity as the polarity termination surface 48b.

The secondary extended magnetically conductive focusing pole 45a is attached to a secondary magnetic polarity surface 64a farthest from a plane of the second surface side 32 of diaphragm 14, and the secondary magnetic structure 41a secondary extended magnetically conductive focusing pole 45a includes openings 92a to increase the acoustical transparency of the secondary extended magnetically conductive focusing pole 45a in the primary acoustic output direction 8a. The second secondary extended magnetically conductive focusing pole 45b is attached to a secondary magnetic polarity surface 64b farthest from a plane of the second surface side 32 of diaphragm 14, and the secondary magnetic structure 41b secondary extended magnetically conductive focusing pole 45b includes openings 92b to increase the acoustical transparency of the second secondary extended magnetically conductive focusing pole 45b in the primary acoustic output direction 8a.

The transducer 10g with secondary magnetic structure 41a including secondary extended magnetically conductive focusing pole 45a form a polarity termination surface 48a adjacent the second surface side 32 of diaphragm 14 that matches the magnetic polarity of magnet row 40b that is also adjacent diaphragm 14 on the opposite surface side, in this example, both having a polarity of ‘N’ or “North”. Transducer 10g also includes secondary magnetic structure 41b including a second secondary extended magnetically conductive focusing pole 45b form a polarity termination surface 48b adjacent the second surface side 32 of diaphragm 14 that matches the magnetic polarity of magnet row 40c that is also adjacent diaphragm 14 on the opposite surface side, in this example, both having a polarity of ‘S’ or “South”.

In this example of the invention, the magnetic energy can be configured with increased symmetrically adjacent both sides 30 and 32 of the diaphragm 14, having increased double sided drive efficiency while exhibiting substantial acoustical transparency with openings 92a and 92b such that the acoustic output in the primary acoustic output direction 8a is substantially unimpeded by the secondary extended magnetically conductive focusing poles 45a and 45b.

FIG. 11 shows an eighth example of the invention with transducer 10h, similar to the transducer 10g of FIG. 10 but instead opposite magnet polarities on the left and right lateral sides of the transducer 10g, the transducer 10h of FIG. 11 uses two primary magnet rows, 40b and 40c of common polarity orientation and the same polarity orientation laterally across the transducer for magnets and focusing pole pieces. The arrangement of the primary magnet rows 40b and 40c being of the same magnetic polarity orientation can strengthen and broaden the fringe fields of magnet rows 40b and 40c in their relationship to conductive trace pattern 34a further enhancing drive force and acoustical output efficiency of the transducer.

The FIG. 11, eighth example of the planar-magnetic transducer invention 10h is comprised of a support frame 12, diaphragm 14, including first surface side 30, second surface side 32, and perimeter of attachment 28a attached to the support frame 12. The perimeter of attachment 28a encompasses the vibratable portion 28b of the diaphragm 14 and the vibratable portion 28b of the diaphragm 14 is held in a predetermined state of tension. In other words, a perimeter portion of diaphragm 14 is supported by support frame 12 such that a vibratable portion 28b of the diaphragm is held in a predetermined state of tension.

A conductive trace pattern 34a is formed on the diaphragm 14 and arranged to receive an electrical input signal. Conductive trace pattern 34a distributed across the diaphragm 14 has first and second outermost lateral edges defining a driven portion 34b of the diaphragm 14. Primary magnetic structure 16 includes primary magnet array 40, including the primary magnet rows 40b and 40c of a common polarity orientation, coupled to, back-plate 22 of the support frame 12. The elongated primary magnet rows 40b and 40c are primarily operable as a source of magnetic fringe fields interacting with the conductive trace pattern 34a. The magnet rows 40b and 40c are positioned adjacent to, and spaced a predetermined gap distance 36 from, the first surface side 30 of the diaphragm 14.

The first secondary magnetic structure 41a is coupled to flange 26a. The secondary magnetic structure 41a includes magnetically conductive focusing pole 44a, to which the South-pole magnetic polarity surface 66a of the secondary magnet 42a is attached. The second secondary magnetic structure 41b is coupled to flange 26b. The secondary magnetic structure 41b includes magnetically conductive focusing pole 44b, to which the South-pole magnetic polarity surface 66b of the secondary magnet 42b is attached.

The secondary magnetic structures 41a and 41b are coupled to flanges 26a and 26b respectively of support frame 12 and are positioned above a plane of the second surface side 32 of the diaphragm 14 with the secondary magnets 42a and 42b positioned, laterally outside of the vibratable portion 28b of the diaphragm 14.

The focusing poles 44a and 44b, of secondary magnetic structures 41a and 41b, are primarily operable as focused magnetic sources which combine with the magnetic fringe fields from primary magnet rows 40b and 40c to maximum magnetic energy which interacting with at least portions of the conductive trace pattern 34a. The secondary magnetic structure 41a includes a secondary extended magnetically conductive focusing pole 45a extending over a portion of the second surface side 32 of the diaphragm 14, with a polarity termination surface 48a spaced away from the second surface side 32 of the diaphragm 14 by a similar or equal distance as primary magnet row 40b is spaced away from the first surface side 30 of diaphragm 14 by gap 36 and secondary magnetic structure 41a polarity termination surface 48a is positioned directly across from primary magnet row 40b.

Also, the secondary magnetic structure 41b includes a second secondary extended magnetically conductive focusing pole 45b extending over a portion of the second surface side 32 of the diaphragm 14, with a polarity termination surface 48b spaced away from the second surface side 32 of the diaphragm 14 by a similar or equal distance as primary magnet row 40c is spaced away from the first surface side 30 of diaphragm 14 by distance gap 36, and secondary magnetic structure 41b polarity termination surface 48b is positioned directly across from primary magnet row 40c.

The polarity termination surface 48a extending over the vibratable portion 28b of second surface side 32 of the diaphragm 14 has a ‘North’ magnetic polarity and the polarity termination surface 48a is positioned across from primary magnet row 40b that has a same ‘North’ magnetic polarity as the polarity termination surface 48a. The polarity termination surface 48b extending over the second surface side 32 of the diaphragm 14 has a ‘North’ magnetic polarity and the polarity termination surface 48b is positioned across from primary magnet row 40c that has a same ‘North’ magnetic polarity as the polarity termination surface 48b. The secondary extended magnetically conductive focusing pole 45a is attached to a secondary magnetic polarity surface 64a farthest from a plane of the second surface side 32 of diaphragm 14, and the secondary magnetic structure 41a secondary extended magnetically conductive focusing pole 45a includes openings 92a to increase the acoustical transparency of the secondary extended magnetically conductive focusing pole 45a in the primary acoustic output direction 8a.

The second secondary extended magnetically conductive focusing pole 45b is attached to a secondary magnetic polarity surface 64b farthest from a plane of the second surface side 32 of diaphragm 14, and the secondary magnetic structure 41b second secondary extended magnetically conductive focusing pole 45b includes openings 92b to increase the acoustical transparency of the second secondary extended magnetically conductive focusing pole 45b in the primary acoustic output direction 8a.

The transducer 10h with secondary magnetic structure 41a including secondary extended magnetically conductive focusing pole 45a form a polarity termination surface 48a adjacent the second surface side 32 of diaphragm 14 that matches the magnetic polarity of magnet row 40b that is also adjacent diaphragm 14 on the opposite, first surface side 30, in this example, both having a polarity of ‘N’ or North. Transducer 10h also includes secondary magnetic structure 41b including second secondary extended magnetically conductive focusing pole 45b form a polarity termination surface 48b adjacent the second surface side 32 of diaphragm 14 that matches the magnetic polarity of magnet row 40c that is also adjacent diaphragm 14 on the opposite surface side 30, in this example both having a polarity of ‘N’ or North.

In this example 10h of the invention, the magnetic energy can be configured with increased symmetry adjacent both sides 30 and 32 of the diaphragm 14, having increased double sided drive efficiency while exhibiting acoustical transparency through openings 92a and 92b such that the acoustic output in the primary acoustic output direction 8a is substantially unimpeded by the secondary extended magnetically conductive focusing poles 45a and 45b.

FIG. 12 shows a ninth example of the invention with transducer 10i that is substantially the same as that shown in FIG. 10, but without the magnetically conductive pole pieces 44a and 44b of secondary magnetic structures 41a and 41b of FIG. 10, now having the coupling secondary magnets 42a and 42b more directly with flanges 26a and 26b. The FIG. 12, ninth example of the planar-magnetic transducer invention 10i is comprised of a support frame 12, diaphragm 14, including first surface side 30, second surface side 32, and perimeter of attachment 28a attached to the support frame 12. The perimeter of attachment 28a encompasses the vibratable portion 28b of the diaphragm 14 and the vibratable portion 28b of the diaphragm 14 is held in a predetermined state of tension. In other words, a perimeter portion of diaphragm 14 is supported by support frame 12 such that a vibratable portion 28b of the diaphragm is held in a predetermined state of tension.

A conductive trace pattern 34a is formed on the diaphragm 14 and arranged to receive an electrical input signal. Conductive trace pattern 34a distributed across the diaphragm 14 has first and second outermost lateral edges defining a driven portion 34b of the diaphragm 14. Primary magnetic structure 16 includes primary magnet array 40, including the primary magnet rows 40b and 40c coupled to, back-plate 22 of the support frame 12. The elongated primary magnet rows 40b and 40c are primarily operable as a source of magnetic fringe fields interacting with the conductive trace pattern 34a. The magnet rows 40b and 40c are positioned adjacent to, and spaced a predetermined gap distance 36 from, the first surface side 30 of the diaphragm 14.

The first secondary magnetic structure 41a is coupled to flange 26a. The secondary magnetic structure 41a includes the secondary magnet row 42a of which the South-pole magnetic polarity surface 66a of the secondary magnet 42a is coupled to flange 26a. The second secondary magnetic structure 41b is coupled to flange 26b. The secondary magnetic structure 41b includes the secondary magnet row 42b of which the North-pole magnetic polarity surface 66b of the secondary magnet 42b is coupled to flange 26b. The secondary magnetic structures 41a and 41b are coupled to flanges 26a and 26b respectively of support frame 12 and are positioned above a plane of the second surface side 32 of the diaphragm 14 with the secondary magnets 42a and 42b positioned, laterally outside of the vibratable portion 28b of the diaphragm 14. The secondary magnetic structure 41a includes a secondary extended magnetically conductive focusing pole 45a extending over a portion of the second surface side 32 of the diaphragm 14, with a polarity termination surface 48a spaced away from the second surface side 32 of the diaphragm 14 by a similar or equal distance as primary magnet row 40b is spaced away from the first surface side 30 of diaphragm 14 by gap distance 36, and secondary magnetic structure 41a polarity termination surface 48a is positioned directly across from primary magnet row 40b.

Also, the secondary magnetic structure 41b includes a second secondary extended magnetically conductive focusing pole 45b extending over a portion of the second surface side 32 of the diaphragm 14, with a polarity termination surface 48b spaced away from the second surface side 32 of the diaphragm 14 by a similar or equal distance as primary magnet row 40c is spaced away from the first surface side 30 of diaphragm 14 by gap distance 36, and secondary magnetic structure 41b polarity termination surface 48b is positioned directly across from primary magnet row 40c.

The polarity termination surface 48a extending over the second surface side 32 of the diaphragm 14 has a ‘North’ magnetic polarity and the polarity termination surface 48a is positioned across from primary magnet row 40b that has a same ‘North’ magnetic polarity as the polarity termination surface 48a. The polarity termination surface 48b extending over the second surface side 32 of the diaphragm 14 has a ‘South’ magnetic polarity and the polarity termination surface 48b is positioned across from primary magnet row 40c that has a same ‘South’ magnetic polarity as the polarity termination surface 48b. The secondary extended magnetically conductive focusing pole 45a is attached to a secondary magnetic polarity surface 64a farthest from a plane of the second surface side 32 of diaphragm 14, and the secondary magnetic structure 41a secondary extended magnetically conductive focusing pole 45a includes openings 92a to increase the acoustical transparency of the secondary extended magnetically conductive focusing pole 45a in the primary acoustic output direction 8a. The second secondary extended magnetically conductive focusing pole 45b is attached to a secondary magnetic polarity surface 64b farthest from a plane of the second surface side 32 of diaphragm 14, and the secondary magnetic structure 41b second secondary extended magnetically conductive focusing pole 45b includes openings 92b to increase the acoustical transparency of the secondary extended magnetically conductive focusing pole 45b in the primary acoustic output direction 8a.

The transducer 10i with secondary magnetic structure 41a including secondary extended magnetically conductive focusing pole 45a form polarity termination surface 48a adjacent the second surface side 32 of diaphragm 14 that matches the magnetic polarity of magnet row 40b that is also adjacent diaphragm 14 on the opposite surface side, in this example, both having a polarity of ‘N’ or ‘North’. Transducer 10i also includes secondary magnetic structure 41b including second secondary extended magnetically conductive focusing pole 45b form a polarity termination surface 48b adjacent the second surface side 32 of diaphragm 14 that matches the magnetic polarity of magnet row 40c that is also adjacent diaphragm 14 on the opposite surface side, in this example, both having a polarity of ‘S or ‘South’. In this example of the invention, the magnetic energy can be configured with increased symmetry adjacent both sides 30 and 32 of the diaphragm 14, having increased double sided drive efficiency while exhibiting substantial acoustical transparency with openings 92a and 92b such that the acoustic output in the primary acoustic output direction 8a is substantially unimpeded by the secondary extended magnetically conductive focusing poles 45a and 45b.

FIG. 13 shows a tenth example of the invention with transducer 10j including primary magnets 47b and 47c oriented with a 90-degree rotation and laterally oriented polarities similar to the transducer of FIG. 9, but with two primary magnet rows instead of one. As with the device of FIG. 9 it is important that the back plate 22a is not a magnetically conductive material. Also, with the lateral orientation of the magnets it is important that the like polarities face each other, as in this case the “north” poles of magnet rows 47b and 47c face each other. This makes for a symmetrical magnetic layout laterally with secondary magnetic structures 41a and 41b being of the same polarity.

The tenth example of the planar-magnetic transducer invention 10j is comprised of a support frame 12, diaphragm 14, including first surface side 30, second surface side 32, and perimeter portion of the diaphragm 28a is supported by, and attached to, the support frame 12. The perimeter of attachment 28a encompasses the vibratable portion 28b of the diaphragm 14 and the vibratable portion 28b of the diaphragm 14 is held in a predetermined state of tension. In other words, a perimeter portion of diaphragm 14 is supported by support frame 12 such that a vibratable portion 28b of the diaphragm is held in a predetermined state of tension.

A conductive trace pattern 34a is formed on the diaphragm 14 and arranged to receive an electrical input signal. Conductive trace pattern 34a distributed across the diaphragm 14 has first and second outermost lateral edges defining a driven portion 34b of the diaphragm 14. Primary magnetic structure 16 includes primary magnet array 40, including the primary magnet rows 47b and 47c of a common polarity orientation, coupled to non-magnetically conductive back-plate 22a of the support frame 12.

The elongated primary magnet rows 47b and 47c are primarily operable as a source of magnetic fringe fields interacting with the conductive trace pattern 34a. The magnet rows 47b and 47c are positioned adjacent to, and spaced a predetermined gap distance 36a from, the first surface side 30 of the diaphragm 14.

A first secondary magnetic structure 41a is coupled to flange 26a. The secondary magnetic structure 41a includes magnetically conductive focusing pole 44a, to which the North-pole magnetic polarity surface 66a of the secondary magnet 42a is attached. The second secondary magnetic structure 41b is coupled to flange 26b. The secondary magnetic structure 41b includes magnetically conductive focusing pole 44b, to which the North-pole magnetic polarity surface 66b of the secondary magnet 42b is attached. The secondary magnetic structures 41a and 41b are coupled to flanges 26a and 26b respectively of support frame 12 and are positioned above a plane of the second surface side 32 of the diaphragm 14 with the secondary magnets 42a and 42b positioned, laterally outside of the vibratable portion 28b of the diaphragm 14.

The focusing poles 44a and 44b, of secondary magnetic structures 41a and 41b, are primarily operable as focused magnetic sources which combine with the magnetic fringe fields from primary magnet rows 47b and 47c to maximum magnetic energy which interacting with at least portions of the conductive trace pattern 34a. The secondary magnetic structure 41a includes a secondary extended magnetically conductive focusing pole 45a extending over a portion of the second surface side 32 of the diaphragm 14, with a magnetically focused polarity termination surface 48a spaced away from the second surface side 32 of the diaphragm 14 by secondary extended focusing pole gap distance 52a which is a similar or equal distance as primary magnet row 47b is spaced away from the first surface side 30 of diaphragm 14 by distance gap 36a and secondary magnetic structure 41a magnetically focused polarity termination surface 48a is positioned directly across from the ‘South’ polarity portion of primary magnet row 40b.

Also, the secondary magnetic structure 41b includes a second secondary extended magnetically conductive focusing pole 45b extending over a portion of the second surface side 32 of the diaphragm 14, with a magnetically focused polarity termination surface 48b spaced away from the second surface side 32 of the diaphragm 14 by secondary extended focusing pole gap distance 52b, a similar or equal distance as primary magnet row 47c is spaced away from the first surface side 30 of diaphragm 14 by gap distance 36a, and secondary magnetic structure 41b magnetically focused polarity termination surface 48b is positioned directly across from a ‘South’ polarity portion of primary magnet row 47c.

The polarity termination surface 48a extending over the second surface side 32 of the diaphragm 14 has a ‘South’ magnetic polarity and the polarity termination surface 48a is positioned across from the portion of primary magnet row 47b that has a same ‘South’ magnetic polarity as the polarity termination surface 48a. The polarity termination surface 48b extending over the second surface side 32 of the diaphragm 14 has a ‘South’ magnetic polarity and the polarity termination surface 48b is positioned across from the portion of the primary magnet row 47c that has a same ‘South’ magnetic polarity as the polarity termination surface 48b. The secondary extended magnetically conductive focusing pole 45a is attached to a secondary magnetic polarity surface 64a farthest from a plane of the second surface side 32 of diaphragm 14, and the secondary magnetic structure 41a secondary extended magnetically conductive focusing pole 45a includes openings 92a to increase the acoustical transparency of the secondary extended magnetically conductive focusing pole 45a in the primary acoustic output direction 8a. The second secondary extended magnetically conductive focusing pole 45b is attached to a secondary magnetic polarity surface 64b farthest from a plane of the second surface side 32 of diaphragm 14, and the secondary magnetic structure 41b second secondary extended magnetically conductive focusing pole 45b includes openings 92b to increase the acoustical transparency of the second secondary extended magnetically conductive focusing pole 45b in the primary acoustic output direction 8a.

The transducer 10j with secondary magnetic structure 41a including secondary extended magnetically conductive focusing pole 45a form a polarity termination surface 48a adjacent the second surface side 32 of diaphragm 14 that matches the magnetic polarity of a portion of the magnet row 47b that is also adjacent diaphragm 14 on the opposite surface side, in this example, both having a polarity of ‘S” or ‘South’. Transducer 10j also includes secondary magnetic structure 41b, including secondary extended magnetically conductive focusing pole 45b, forming a polarity termination surface 48b adjacent the second surface side 32 of diaphragm 14 that matches the magnetic polarity of magnet row 47c that is also adjacent diaphragm 14 on the opposite surface side, in this example, both having a polarity of ‘S’ or South.

In this example of the invention, the magnetic energy can be configured with increased symmetry adjacent both sides 30 and 32 of the diaphragm 14, having increased double sided drive efficiency while exhibiting substantial acoustical transparency with openings 92a and 92b such that the acoustic output in the primary acoustic output direction 8a is substantially unimpeded by the secondary extended magnetically conductive focusing poles 45a and 45b.

An eleventh example of the invention 10k shown in FIG. 14, is similar to the device of FIG. 10 with two main differences. First, the secondary extended magnetically conductive focusing pole pieces 45a and 45b have been removed from the secondary magnetic structures 41a and 41b, and secondly, the secondary focusing poles 44a and 44b of transducer 10a of FIG. 14 have been shaped to be extended slightly over diaphragm 14 without touching diaphragm 14 due to elevation the formation of clearance cavity gaps 50a and 50b. This allows the focusing plates 44a and 44b to get closer to, and more precisely focus their magnetic fields through, the conductive traces 34 on diaphragm 14 while providing increased mobility of diaphragm 14 near the perimeter of attachment 28a. This approach to focusing plates 44a and 44b could be incorporated in most of the disclosed examples of the invention. Additionally, as an option to promote acoustic transparency, acoustic energy emitted from diaphragm 14 in an a primary acoustic direction 8a can be enhanced by creating selective openings in the focusing plates 44a and 44b, as illustrated in a cut-away plan view of this eleventh example of the inventive transducer openings 93 in FIG. 23.

The eleventh example 10k of the planar-magnetic transducer invention is comprised of a support frame 12, diaphragm 14, including first surface side 30, second surface side 32, and perimeter of attachment 28a attached to the support frame 12. The perimeter of attachment 28a encompasses the vibratable portion 28b of the diaphragm 14 and the vibratable portion 28b of the diaphragm 14 is held in a predetermined state of tension. In other words, a perimeter portion of diaphragm 14 is supported by support frame 12 such that a vibratable portion 28b of the diaphragm is held in a predetermined state of tension.

A conductive trace pattern 34a is formed on the diaphragm 14 and arranged to receive an electrical input signal. Conductive trace pattern 34a distributed across the diaphragm 14 has first and second outermost lateral edges defining a driven portion 34b of the diaphragm 14. Primary magnetic structure 16 includes primary magnet array 40, including the primary magnet rows 40b and 40c of a common polarity orientation, coupled to, back-plate 22 of the support frame 12. The elongated primary magnet rows 40b and 40c are primarily operable as a source of magnetic fringe fields interacting with the conductive trace pattern 34a. The magnet rows 40b and 40c are positioned adjacent to, and spaced a predetermined gap distance 36a from, the first surface side 30 of the diaphragm 14.

The first secondary magnetic structure 41a is coupled to flange 26a. The secondary magnetic structure 41a includes magnetically conductive focusing pole 44a, to which the South-pole magnetic polarity surface 66a of the secondary magnet 42a is attached. The second secondary magnetic structure 41b is coupled to flange 26b. The secondary magnetic structure 41b includes magnetically conductive focusing pole 44b, to which the North-pole magnetic polarity surface 66b of the secondary magnet 42b is attached.

The secondary magnetic structures 41a and 41b are coupled to flanges 26a and 26b respectively of support frame 12 and are positioned above a plane of the second surface side 32 of the diaphragm 14 with the secondary magnets 42a and 42b positioned, laterally outside of the vibratable portion 28b of the diaphragm 14. The focusing poles 44a and 44b, of secondary magnetic structures 41a and 41b, are primarily operable as focused magnetic sources which combine with the magnetic fringe fields from primary magnet rows 40b and 40c to maximum magnetic energy which interacting with at least portions of the conductive trace pattern 34a.

As another aspect of the planar magnetic transducer 10k of FIG. 14, the secondary magnetic structure 41a is positioned at a first lateral sidewall 24a of the transducer device, the secondary magnetic structure 41a includes the secondary magnet 42a with the secondary magnet 42a having a first magnetic polarity surface 66a, where a magnetically conductive focusing pole 44a is attached to the first magnetic polarity surface 66a of the at least one secondary magnet 42a. The primary magnet row 40b closest to the first lateral sidewall 24a of the support frame 12 has a primary magnetic polarity surface coupled to the magnetically conductive back-plate 22 and the primary magnetic polarity surface has an ‘S’ or ‘South’ primary magnetic polarity. The magnetically conductive backplate 22 is magnetically coupled through the magnetically conductive sidewall 24a to the magnetically conductive secondary focusing pole 44a of the secondary magnet structure 41a. The first magnetic polarity surface 66a of the secondary magnet 42a has a secondary magnetic polarity ‘S’ or ‘South’ such that the primary magnetic polarity and the first secondary magnetic polarity are the same ‘S’ or ‘South’ magnetic polarity.

The secondary magnetic structure 41b is positioned at a second lateral sidewall 24b of the transducer device, the secondary magnetic structure 41b includes the secondary magnet 42b with the secondary magnet 42b having a first magnetic polarity surface 66b, where a magnetically conductive focusing pole 44b is attached to the first magnetic polarity surface 66b of the at least one secondary magnet 42b. The primary magnet row 40c closest to the second lateral sidewall 24b of the support frame 12 has a primary magnetic polarity surface coupled to the magnetically conductive back-plate 22 and the primary magnetic polarity surface has an ‘N’ or ‘North’ primary magnetic polarity. The magnetically conductive backplate 22 is magnetically coupled through the magnetically conductive sidewall 24b to the magnetically conductive secondary focusing pole 44b of the secondary magnet structure 41b. The first magnetic polarity surface 66b of the secondary magnet 42b has a secondary magnetic polarity ‘N’ or ‘North’ such that the primary magnetic polarity and the first secondary magnetic polarity are the same ‘N’ or ‘North’ magnetic polarity.

This example of the invention 10k has increased double sided drive efficiency while exhibiting substantial acoustic transparency such that the acoustic output in the primary acoustic output direction 8a is unimpeded.

Transducer 10l, a twelfth example of the invention shown in FIG. 15, is similar to the device of FIG. 13 except for two main differences. First, the secondary extended magnetically conductive focusing pole pieces 45a and 45b have been removed from the secondary magnetic structures 41a and 41b, and acoustic waveguides 108a and 108b have been added. The acoustic waveguides can create a smoother surface for acoustic wave fronts to form against as they are generated by transducer 10l to minimize diffraction and tailor the acoustic output in the primary acoustic propagation direction 8a. The waveguides can take on a number of forms and sizes depending on the bandwidth of the transducer and the desired acoustical effect. In most cases, the waveguides are preferably constructed of non-magnetically-conductive materials.

The twelfth example of the planar-magnetic transducer invention 10l is comprised of a support frame 12, diaphragm 14, including first surface side 30, second surface side 32, and perimeter of attachment 28a attached to the support frame 12. The perimeter of attachment 28a encompasses the vibratable portion 28b of the diaphragm 14 and the vibratable portion 28b of the diaphragm 14 is held in a predetermined state of tension. In other words, a perimeter portion of diaphragm 14 is supported by support frame 12 such that a vibratable portion 28b of the diaphragm is held in a predetermined state of tension.

A conductive trace pattern 34a is formed on the diaphragm 14 and arranged to receive an electrical input signal. Conductive trace pattern 34a distributed across the diaphragm 14 has first and second outermost lateral edges defining a driven portion 34b of the diaphragm 14. Primary magnetic structure 16 includes primary magnet array 40, including the primary magnet rows 47b and 47c which are polarity rotated 90-degrees and are of an opposing polarity orientation, having North and South polarity portions coupled to non-magnetically conductive back-plate 22a of the support frame 12. The elongated primary magnet rows 47b and 47c are primarily operable as a source of magnetic fringe fields interacting with the conductive trace pattern 34a. The magnet rows 47b and 47c are positioned adjacent to, and spaced a predetermined gap distance 36a from, the first surface side 30 of the diaphragm 14.

A first secondary magnetic structure 41a is coupled to flange 26a. The secondary magnetic structure 41a includes magnetically conductive focusing pole 44a, to which the North-pole magnetic polarity surface 66a of the secondary magnet 42a is attached. The second secondary magnetic structure 41b is coupled to flange 26b. The secondary magnetic structure 41b includes magnetically conductive focusing pole 44b, to which the ‘North-pole’ magnetic polarity surface 66b of the secondary magnet 42b is attached. The secondary magnetic structures 41a and 41b are coupled to flanges 26a and 26b respectively of support frame 12 and are positioned above a plane of the second surface side 32 of the diaphragm 14 with the secondary magnets 42a and 42b positioned, laterally outside of the vibratable portion 28b of the diaphragm 14.

The focusing poles 44a and 44b, of secondary magnetic structures 41a and 41b, are primarily operable as focused magnetic sources which combine with the magnetic fringe fields from primary magnet rows 47b and 47c to maximum magnetic energy which interacting with at least portions of the conductive trace pattern 34a.

This example of the invention 10l has increased double sided drive efficiency while exhibiting substantial acoustic transparency such that the acoustic output in the primary acoustic output direction 8a is unimpeded.

Transducer 10m of a thirteenth example of the invention shown in FIG. 16 is structurally similar to the device of FIG. 11 except for the added magnetically conductive passive return pole 16, which derives its “S” South polarity magnetic energy from primary magnets 40b and 40c through magnetically conductive back plate 22 due to both primary magnets having the same “South” magnetic polarity orientation relative to back plate 22.

The FIG. 16, thirteenth example of the planar-magnetic transducer invention 10m is comprised of a support frame 12, diaphragm 14, including first surface side 30, second surface side 32, and perimeter of attachment 28a attached to the support frame 12. The perimeter of attachment 28a encompasses the vibratable portion 28b of the diaphragm 14 and the vibratable portion 28b of the diaphragm 14 is held in a predetermined state of tension. In other words, a perimeter portion of diaphragm 14 is supported by support frame 12 such that a vibratable portion 28b of the diaphragm is held in a predetermined state of tension.

A conductive trace pattern 34a is formed on the diaphragm 14 and arranged to receive an electrical input signal. Conductive trace pattern 34a distributed across the diaphragm 14 has first and second outermost lateral edges defining a driven portion 34b of the diaphragm 14. Primary magnetic structure 16 includes primary magnet array 40, including the primary magnet rows 40b and 40c of a common polarity orientation, coupled to, back-plate 22 of the support frame 12 and further including passive magnetically conductive return pole row 46. The elongated primary magnet rows 40b and 40c, and passive magnetically conductive return pole row 46, are primarily operable as a source of magnetic fringe fields interacting with the conductive trace pattern 34a. The magnet rows 40b and 40c are positioned adjacent to, and spaced a predetermined gap distance 36a from, the first surface side 30 of the diaphragm 14. Passive magnetically conductive return pole row 46 preferably has the same gap distance 36a of magnet rows 40b and 40c, but in certain cases may be slightly more or slightly less.

The first secondary magnetic structure 41a is coupled to flange 26a. The secondary magnetic structure 41a includes magnetically conductive focusing pole 44a, to which the ‘South-pole’ magnetic polarity surface 66a of the secondary magnet 42a is attached. The second secondary magnetic structure 41b is coupled to flange 26b. The secondary magnetic structure 41b includes magnetically conductive focusing pole 44b, to which the South-pole magnetic polarity surface 66b of the secondary magnet 42b is attached. The secondary magnetic structures 41a and 41b are coupled to flanges 26a and 26b respectively of support frame 12 and are positioned above a plane of the second surface side 32 of the diaphragm 14 with the secondary magnets 42a and 42b positioned, laterally outside of the vibratable portion 28b of the diaphragm 14. The magnetically conductive focusing poles 44a and 44b, of secondary magnetic structures 41a and 41b, are primarily operable as focused magnetic sources which combine with the magnetic fringe fields from primary magnet rows 40b and 40c to maximum magnetic energy which interacting with at least portions of the conductive trace pattern 34a.

The secondary magnetic structure 41a includes a secondary extended magnetically conductive focusing pole 45a extending over a portion of the second surface side 32 of the diaphragm 14, with a magnetically focused polarity termination surface 48a spaced away from the second surface side 32 of the diaphragm 14 by a similar or equal gap distance as primary magnet row 40b gap distance 36a is spaced away from the first surface side 30 of diaphragm 14 and secondary magnetic structure 41a magnetically focused polarity termination surface 48a is positioned directly across from primary magnet row 40b. Also, the secondary magnetic structure 41b includes a second secondary extended magnetically conductive focusing pole 45b extending over a portion of the second surface side 32 of the diaphragm 14, with a magnetically focused polarity termination surface 48b spaced away from the second surface side 32 of the diaphragm 14 by a similar or equal distance as primary magnet row 40c is spaced away from the first surface side 30 of diaphragm 14 with distance gap 36a and secondary magnetic structure 41b magnetically focused polarity termination surface 48b is positioned directly across from primary magnet row 40c.

The polarity termination surface 48a extending over the second surface side 32 of the diaphragm 14 has a ‘North’ N′ magnetic polarity and the polarity termination surface 48a is positioned across from primary magnet row 40b that has a same ‘North’ ‘N’ magnetic polarity as the polarity termination surface 48a. The polarity termination surface 48b extending over the second surface side 32 of the diaphragm 14 has a ‘North’ N′ magnetic polarity and the polarity termination surface 48b is positioned across from primary magnet row 40c that has a same ‘North’ N′ magnetic polarity as the polarity termination surface 48b. The secondary extended magnetically conductive focusing pole 45a is attached to a secondary magnetic polarity surface 64a farthest from a plane of the second surface side 32 of diaphragm 14, and the secondary magnetic structure 41a secondary extended magnetically conductive focusing pole 45a includes openings 92a to increase the acoustical transparency of the secondary extended magnetically conductive focusing pole 45a in the primary acoustic output direction 8a. The secondary extended magnetically conductive focusing pole 45b is attached to a secondary magnetic polarity surface 64b farthest from a plane of the second surface side 32 of diaphragm 14, and the secondary magnetic structure 41b secondary extended magnetically conductive focusing pole 45b includes openings 92b to increase the acoustical transparency of the secondary extended magnetically conductive focusing pole 45b in the primary acoustic output direction 8a.

The transducer 10m with secondary magnetic structure 41a including secondary extended magnetically conductive focusing pole 45a form a polarity termination surface 48a adjacent the second surface side 32 of diaphragm 14 that matches the magnetic polarity of magnet row 40b that is also adjacent diaphragm 14 on the opposite surface side 30, in this example, both having a polarity of ‘N’ or North.

Transducer 10m also includes secondary magnetic structure 41b including second secondary extended magnetically conductive focusing pole 45b form a polarity termination surface 48b adjacent the second surface side 32 of diaphragm 14 that matches the magnetic polarity of magnet row 40c that is also adjacent diaphragm 14 on the opposite surface side 30, in this example, both having a polarity of ‘N’ or North.

As another aspect of planar magnetic transducer 10m of FIG. 16, the primary magnetic structure 16 includes at least two primary magnet rows 40b and 40c, and at least one passive magnetically conductive return pole row 46 coupled to the backplate 22 of the support frame 12. The passive magnetically conductive return pole row 46 is positioned between, and in parallel with, the two primary magnet rows 40b and 40c, and spaced a predetermined distance 36a from, the first surface side 30 of the vibratable portion 28b of diaphragm 12.

In this example of the invention, the magnetic energy can be configured with increased symmetry adjacent both sides 30 and 32 of the diaphragm 14, having increased double sided drive efficiency while exhibiting acoustical transparency with openings 92a and 92b such that the acoustic output in the primary acoustic output direction 8a is substantially unimpeded by the secondary extended magnetically conductive focusing poles 45a and 45b.

FIG. 17 shows the fourteenth example 10n of the planar-magnetic transducer invention which is comprised of a support frame 12, diaphragm 14, including first surface side 30, second surface side 32, and perimeter of attachment 28a attached to the support frame 12. The perimeter of attachment 28a encompasses the vibratable portion 28b of the diaphragm 14 and the vibratable portion 28b of the diaphragm 14 is held in a predetermined state of tension. In other words, a perimeter portion of diaphragm 14 is supported by support frame 12 such that a vibratable portion 28b of the diaphragm is held in a predetermined state of tension.

A conductive trace pattern 34a is formed on the diaphragm 14 and arranged to receive an electrical input signal. Conductive trace pattern 34a distributed across the diaphragm 14 has first and second outermost lateral edges defining a driven portion 34b of the diaphragm 14. Primary magnetic structure 16 includes primary magnet array 40, including the primary magnet rows 40b and 40c coupled to back-plate 22 of the support frame 12. The elongated primary magnet rows 40b and 40c are primarily operable as a source of magnetic fringe fields interacting with the conductive trace pattern 34a. The magnet rows 40b and 40c are positioned adjacent to, and spaced a predetermined gap distance 36a from, the first surface side 30 of the diaphragm 14.

The first secondary magnetic structure 41a is coupled to flange 26a and sidewall 24a of support frame 12. The secondary magnetic structure 41a includes magnetically conductive focusing pole 44c, to which the ‘South-pole’ magnetic polarity surface 66a of the secondary magnet 42a is attached. The second secondary magnetic structure 41b is coupled to flange 26b and sidewall 24b of support frame 12. The secondary magnetic structure 41b includes magnetically conductive focusing pole 44d, to which the ‘North-pole’ magnetic polarity surface 66b of the secondary magnet 42b is attached. The secondary magnetic structures 41a and 41b coupled to flanges 26a and 26b and sidewalls 24a and 24b respectively of support frame 12, are positioned above a plane of the second surface side 32 of the diaphragm 14 with the secondary magnets 42a and 42b positioned, laterally outside of the vibratable portion 28b of the diaphragm 14. The focusing poles 44c and 44d, of secondary magnetic structures 41a and 41b, are primarily operable as focused magnetic sources which combine with the magnetic fringe fields from primary magnet rows 40b and 40c to maximum magnetic energy which interacting with at least portions of the conductive trace pattern 34a. This example of the invention 10n further includes support blocks 49a and 49b to add further structural support to secondary magnet structures 41a and 41b, and to also provide a more extended surface to effectively capture and support the attachment of diaphragm 14.

In this example the passive magnetic return path from primary magnet row 40b has a South ‘S’ magnetic polarity coupled through magnetically conductive back plate 22, up magnetically conductive sidewall 24a and further magnetically coupled to North ‘N’ polarity magnetic polarity surface 64a of secondary magnet 42a, which completes a magnetic path loop by having South ‘S’ polarity magnetic polarity surface 66a magnetically coupled to magnetically conductive focusing pole 44c. Also, in this example transducer 10n, the passive magnetic return path from primary magnet row 40c has a North ‘N’ magnetic polarity coupled through magnetically conductive back plate 22, up magnetically conductive sidewall 24b and further magnetically coupled to South ‘S’ polarity magnetic polarity surface 64b of secondary magnet 42b, which completes a magnetic path loop by having North ‘N’ polarity magnetic polarity surface 66b magnetically coupled to magnetically conductive focusing pole 44d. The ‘South’ polarity of magnet row 40b is magnetically coupled through back plate 22 and through sidewall 24a to magnetically conductive focusing pole 44c. The ‘North’ polarity of magnet row 40c is magnetically coupled through back plate 22 and through sidewall 24b to magnetically conductive focusing pole 44d.

As another aspect of the planar magnetic transducer 10n of FIG. 17, the secondary magnetic structure 41a is positioned at a first lateral sidewall 24a of the transducer device, the secondary magnetic structure 41a includes the secondary magnet 42a with the secondary magnet 42a having a first magnetic polarity surface 66a, where a magnetically conductive focusing pole 44c is attached to the first magnetic polarity surface 66a of the at least one secondary magnet 42a. The primary magnet row 40b closest to the first lateral sidewall 24a of the support frame 12 has a primary magnetic polarity surface coupled to the magnetically conductive back-plate 22 and the primary magnetic polarity surface has an ‘S’ or ‘South’ primary magnetic polarity. The magnetically conductive backplate 22 is magnetically coupled through the magnetically conductive sidewall 24a to the magnetically conductive secondary focusing pole 44c of the secondary magnet structure 41a. The first magnetic polarity surface 66a of the secondary magnet 42a has a secondary magnetic polarity ‘S’ or ‘South’ such that the primary magnetic polarity and the first secondary magnetic polarity are the same ‘S’ or ‘South’ magnetic polarity.

The secondary magnetic structure 41b is positioned at a second lateral sidewall 24b of the transducer device, the secondary magnetic structure 41b includes the secondary magnet 42b with the secondary magnet 42b having a first magnetic polarity surface 66b, where a magnetically conductive focusing pole 44d is attached to the first magnetic polarity surface 66b of the at least one secondary magnet 42b. The primary magnet row 40c closest to the second lateral sidewall 24b of the support frame 12 has a primary magnetic polarity surface coupled to the magnetically conductive back-plate 22 and the primary magnetic polarity surface has an ‘N’ or ‘North’ primary magnetic polarity. The magnetically conductive backplate 22 is magnetically coupled through the magnetically conductive sidewall 24b to the magnetically conductive secondary focusing pole 44d of the secondary magnet structure 41b. The first magnetic polarity surface 66b of the secondary magnet 42b has a secondary magnetic polarity ‘N’ or ‘North’ such that the primary magnetic polarity and the first secondary magnetic polarity are the same ‘N’ or ‘North’ magnetic polarity.

The planar magnetic transducer example 10n has increased, double sided drive efficiency while exhibiting substantial acoustic transparency such that the acoustic output in the primary acoustic output direction 8a is unimpeded.

Referring now to FIG. 14 and FIG. 17, FIG. 14 shows a first lateral x-axis primary magnet row 40b, closest to sidewall 24a, has a polarity orientation with a ‘N’ or ‘North’ polarity “up” relative to y-axis or towards the first surface side 30 of diaphragm 14, and an ‘S’ or ‘South’ polarity “down” relative to y-axis, towards the backplate 22, and a first lateral x-axis secondary magnet 42a has the same ‘N’ or ‘North’ polarity “up” and ‘S’ or ‘South’ polarity “down” orientation as primary magnet row (shown in these figures as 40b), closest to sidewall 24a. FIG. 17 shows the same relationships but with first secondary magnet 42a rotated counter clockwise by 90-degrees. It is desirable in all preferred embodiments that in the inventive planar magnetic transducer that the maximum rotation of secondary magnet be positioned from zero to 90-degrees, but no more than a 90-degree rotation relative to the nearest primary magnet row, shown in these FIGS. 14 and 17 as 40b.

FIG. 14 shows a second lateral x-axis primary magnet row 40c closest to sidewall 24b, has a polarity orientation with an ‘S’ or ‘South’ polarity “up” relative to y-axis or towards the first surface side 30 of diaphragm 14, and an ‘N’ or ‘North’ polarity “down” relative to y-axis, towards the backplate 22, and a first lateral x-axis secondary magnet 42a has the same ‘S’ or ‘South’ polarity “up” and ‘N’ or ‘North’ polarity “down” orientation as second primary magnet row closest to sidewall 24b, which is primary magnet row 40c in this illustration. FIG. 17 shows the same relationships but with first secondary magnet 42a rotated clockwise by 90-degrees. It is desirable in all preferred embodiments that in the inventive planar magnetic transducer that the maximum rotation of the secondary magnet be positioned from zero to 90-degrees, but no more than a 90-degree rotation relative to the nearest primary magnet row, shown in these FIGS. 14 and 17 as 40b.

FIG. 18 shows a cross sectional view of an alternate version of secondary magnetic structure 41b which could be substituted in place of the secondary magnetic structure 41b of FIG. 17. This cut-away view of secondary magnet structure 41b, shows partial diaphragm 14 and conductive pattern 34a, sidewall 24b, flange 26b, magnet 42b and focus pole 44d. In this example, the focus pole 44d is slightly elevated off of diaphragm 14 with separation space 50b, allowing the diaphragm to be wider and have movement under the focus pole 44d, which may increase total diaphragm area and the output capability of the inventive transducer. The focus pole 44d may have openings to increase acoustic transparency, similar to the ones illustrated in openings 93 of the cut-away plan view of FIG. 23.

FIG. 19 shows a fifteenth example of the invention with transducer 10o which is based on the same general structure of the invention as shown in FIG. 1A, while increasing the number of primary magnet rows 40 to a total of five magnet rows. Added is an enclosure 110 attached in a substantially sealed relationship to support frame 12 of transducer 10o. The enclosure may be filled with acoustically absorbent material 112, such as acoustic foam, fiberglass, Dacron or some other acoustically lossy material. The support frame 12 supports primary magnetic magnet array 40 on magnetically conductive backplate 22. The transducer 10o includes secondary magnet structures 41a and 41b, coupled to flanges 26a and 26b respectively, and including magnets 42a and 42b and focusing poles 44a and 44b respectively. Diaphragm 14 has a first surface side 30 and second surface side 32 with conductive pattern 34a formed on the second surface side 32 of diaphragm 14. A perimeter portion of diaphragm 14 is supported by support frame 12 such that a vibratable portion 28b of the diaphragm 14 is held in a predetermined state of tension.

Openings 90, in back plate 22, allow acoustic energy from first surface side 30 to radiate through acoustic damping material 91 and on into enclosure 110. Acoustic energy radiating from second surface side 32 of transducer 10o radiates freely without interference in primary acoustic path direction 8a.

FIG. 20 shows a sixteenth example of the invention with transducer 10p. The support frame 12 supports primary magnetic structure 16 with primary magnetic magnet array 40 attached to, preferably magnetically conductive, backplate 22, which is mechanically and magnetically coupled to sidewalls 24a and 24b. Primary magnet array 40 includes four rows of primary magnets, 40d, 40e, 40f, and 40g. The transducer 10p further includes secondary magnet structures 41a and 41b, coupled to flanges 26a and 26b respectively, and including magnets 42a and 42b and focusing poles 44a and 44b respectively. Diaphragm 14 has a first surface side 30 and second surface side 32 with conductive pattern 34a formed on the second surface side 32 of diaphragm 14. A perimeter portion of diaphragm 14 is supported by support frame 12 such that a vibratable portion 28b of the diaphragm 14 is held in a predetermined state of tension.

Openings 90, in back plate 22, allow acoustic energy from first surface side 30 to radiate through acoustic damping material 91. Central primary magnet rows 40e and 40f have a gap spacing distance 36a from first surface side 30 of diaphragm 14. Outer primary magnet rows 40d and 40g have a smaller gap spacing distance 36b from first surface side 30 of diaphragm 14 than that of gap spacing distance 36a, which may increase magnetic energy to portions of conductive trace pattern 34a. Acoustic energy radiating from second surface side 32 of transducer 10p radiates freely without interference in primary acoustic path direction 8a.

FIG. 21 shows a cross sectional view of an alternate format of secondary magnetic structure 41b which could be substituted in place of the secondary magnetic structure 41b of previously disclosed examples of the invention. This cut-away view of secondary magnet structure 41b, shows partial diaphragm 14 with first surface side 30 and second surface side 32 and conductive pattern 34a, sidewall 24b, flange 26b, magnet 42b and focus pole 44d. In this example, a primary focus return pole 27b is shown coupled to the flange 26b and sidewall 24b and also connected against a first surface side 30 of diaphragm 14, while secondary focus plate 44b is connected against a second surface 32 of diaphragm 14 and coupled to primary focus return pole 27b and secondary magnet 42b. This approach can provide greater magnetic field focus from primary focus pole 27b and secondary focus pole 44b to conductive trace pattern 34a and may increase diaphragm mobility and acoustic output capability of the invention.

FIG. 22 shows another cross sectional view of an alternate format of secondary magnetic structure 41b, which could be substituted in place of the secondary magnetic structure 41b of previously disclosed examples of the invention. This cut-away view of secondary magnet structure 41b, shows partial diaphragm 14 with first surface side 30 and second surface side 32 and conductive pattern 34a, sidewall 24b, flange 26b, magnet 42b and focus pole 44b. In this example, a primary focus return pole 27b is shown coupled to the flange 26b and sidewall 24b and spaced away from a first surface side 30 of diaphragm 14, with gap opening 50d while secondary focus plate 44b has a portion elevated off of the second surface side 32 of diaphragm 14, with gap opening 50b, and focus plate 44b is coupled to flange 26b and connected to secondary magnet 42b.

The focus pole 44b may have openings to increase acoustic transparency, similar to the ones illustrated in openings 93 of secondary focusing pole 44a of the cut-away plan view of FIG. 23. The use of gap openings 50b and 50d allow a projection of focusing poles 44b and 27b to be closer to conductive traces 34a and also allow a wider diaphragm 14 which may provide greater diaphragm mobility and greater acoustic output capability in the inventive transducer.

FIG. 23 shows a partial plan view of the invention, diaphragm 14 (not shown) removed for clarity. Shown is support frame 12, primary magnet row 40b, and flange 26a, supporting secondary magnet structure 41a, with secondary magnet row 42a and secondary focus pole plate 44a. This view shows focus pole plate 44a extending laterally towards the center of the transducer (as shown in FIG. 14) with focus pole plate 44a having slot openings 93 which may provide greater acoustic transparency and reduced acoustical loading of the diaphragm.

FIG. 24 shows a plan view of a first example of a conductive trace pattern 34a on an example diaphragm 14 of the invention, with bounded lateral width 34b of the conductive traces 34a. Electrical end run return traces 96a and 96b show what may be lossy return trace paths, normally undriven, but activated with use of example of the invention 10b of FIG. 4, with secondary magnetic structures 41c, 41d, and 41e. Shown in 94a is the current path direction for one electrical polarity of an electrical input signal connected to input connections 98a and 98b. The particular trace pattern 34a of FIG. 24 is compatible with the invention examples of figures; 1A, 1B, 4, 5A, 5B 7A, 7B, 13, 14, and 15. The conductive trace pattern 34a may be formed on (referring to FIG. 1A) a first surface side 30 or the second surface side 32 or conductive trace patterns may be formed on both surface sides of the diaphragm 14. The trace pattern 34a may be conductively seamless or may be broken into different conductive sections not electrically connected to each other.

FIG. 25 shows a plan view of a second example of a conductive trace pattern 34a on an example diaphragm 14 of the invention, with bounded lateral width 34b of the conductive traces 34a. Shown in 94b is the current path direction for one electrical polarity of an electrical input signal connected to input connections 98c and 98d. The particular trace pattern 34a of FIG. 25 is compatible with the invention examples of figures; 10, 12, and 17.

Referring to FIG. 24 and FIG. 1A, the conductive trace pattern 34a may be composed of a of a single layer of conductive foil with a plane of the conductive foil in parallel with a plane of the vibratable portion 28b of the diaphragm 14 and attached to the second surface side 32 of the vibratable portion 28 of the diaphragm 14, as shown, and an additional, second conductive trace pattern (not shown) with a of a single layer of conductive foil with a plane of the conductive foil in parallel with the plane of the vibratable portion 28b of the diaphragm may be attached to the first surface side of the diaphragm 30.

Various materials and processes known in the art of planar magnetic transducers may be applied to the invention. Thin film diaphragms may consist of polyester, polyamide, PEEK, PEN™ or Mylar™, or any other suitable thin flexible film as a substrate may be applied. The thin film is preferably less than 2 mil in thickness, and more preferably less than 1 mil in thickness. Any material functionally similar to the examples described above may be appropriate for use as a thin film diaphragm as described in this application.

Conductive traces may be derived from many conductive materials, such as aluminum, copper or other conductors. Many conductor forms may work well, with thin metal films or tape, or strips being preferable. The conductive trace pattern may be of fairly wide range of thicknesses about 1 mil depending on the desired resistance, trace length, and mass that is optimal for a specific application. The diaphragm and conductor can be constructed with a variety of techniques known in the art of planar magnetic transducers. A polymer film substrate may be applied with a thin adhesive with a metal conductive sheet adhered to the polymer diaphragm material, and then the conductor can be etched to form the desired conductive trace pattern.

Other methods can be used, such as laying up conductive tape on a polymer diaphragm, vapor deposition, or other deposition means for applying a conductor to a film diaphragm. Also methods can be used where the polymer is poured or cast onto the conductive metal foil and formed to the desired thickness, with or without an adhesive layer. This can work well with polyamide/Kapton™ materials.

The diaphragm 14, including the conductive traces 34a applied thereto, may be held flat or alternatively, deformed to create lines of flexion such as by knurling, pressing, embossing, corrugating or the like, prior to being placed under tension within a support frame so as to achieve advantages, including, but not limited to, reducing loss of diaphragm tension, reducing distortion or resonance modes along active surface areas of the diaphragm when electrical energy is applied through the conductor trace pattern. A plurality of generally parallel lines of flexion may be created across the at least a portion of the diaphragm including the conductive trace pattern mounted thereto, with the lines being made transversely and, more preferably, generally perpendicularly with respect to the length of the conductive traces extending along at least one surface side of the diaphragm.

The diaphragm 14 may be placed under tension in width direction, in a length direction or both, or some differentiation of tension depending on other design parameters. For example if the diaphragm is corrugated in one direction, the diaphragm may be more or less to allow the corrugations to maintain integrity of form, or tension may be only in a length or width direction, or tension may be adequately created by the deformation or corrugation itself.

Magnets incorporated in the invention can be of high energy types such as Neodymium or Samarium-cobalt, or medium energy product magnets such as ferrite magnets, Ceramic 5 and Ceramic 8, or lower energy magnets such as impregnated rubber or plastic magnets, or any quality magnet type may be utilized as can be formed and applied to a planar magnetic transducer.

All the disclosed examples provide different forms of the invention of which each embody the fundamental advantages of the invention relative to the prior art.

It is evident that those skilled in the art may now understand how various configurations can be realized by way of mixing and matching combinations of the novel structures disclosed in the figures, and also make numerous uses of and departures from the specific apparatus and techniques disclosed herein without departing from the inventive concepts. Consequently, the invention is to be construed as embracing each and every novel feature and novel combination of features disclosed herein.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention.

What is claimed is:

1. A planar-magnetic transducer device for generating an acoustic output based on an electrical signal, comprising;
a support frame,
a diaphragm including a first surface side and a second surface side, where a perimeter portion of the diaphragm is supported by the support frame such that a vibratable portion of the diaphragm is held in a predetermined state of tension,
a conductive trace pattern formed on the diaphragm and arranged to receive an electrical input signal,
a primary magnetic structure including at least one primary magnet row coupled to the support frame, where
each primary magnet row is positioned adjacent to, and spaced a predetermined distance from, the first surface side of the vibratable portion of the diaphragm and is operable as a fringe field source interacting with at least a portion of the conductive trace pattern,
at least one secondary magnetic structure positioned at a first lateral side of the transducer device, the secondary magnetic structure including at least one secondary magnet with the secondary magnet having a first magnetic polarity surface and a second magnetic polarity surface, where a magnetically conductive focusing pole is attached to the first magnetic polarity surface of the at least one secondary magnet,
the at least one secondary magnetic structure is mounted to the support frame and positioned above a plane of the second surface side of the diaphragm with the at least one secondary magnet positioned laterally outside of the vibratable portion of the diaphragm,
the magnetically conductive focusing pole of the secondary magnetic structure operable as a focused field magnetic source interacting with at least a portion of the conductive trace pattern, and
the electrical signal is applied to the conductive trace pattern such that the primary magnet row fringe field and the secondary magnetic structure focused field cause movement of the conductive trace pattern and the vibratable portion of the diaphragm, thereby generating the acoustic output.

2. The planar-magnetic transducer of claim 1, including;
a first outermost lateral edge of the conductive trace pattern and a second outermost lateral edge of the conductive trace pattern bounding a driven portion of the vibratable portion of the diaphragm, wherein
the secondary magnet structure magnetically conductive focusing pole is positioned laterally outside of the driven portion of the vibratable portion of the diaphragm.

3. The planar-magnetic transducer of claim 1, wherein;
the secondary magnet structure magnetically conductive focusing pole extends over a portion of the second surface side of the vibratable portion of the diaphragm and is spaced a predetermined focusing pole gap distance away from the second surface side of the diaphragm.

4. The planar-magnetic transducer of claim 1, wherein;
the secondary magnet structure magnetically conductive focusing pole extends over a portion of the second surface side of the vibratable portion of the diaphragm and is spaced a predetermined focusing pole gap distance away from the second surface side of the diaphragm,
the magnetically conductive focusing pole includes openings for increasing an acoustical transparency of the magnetically conductive focusing pole.

5. The planar-magnetic transducer of claim 1, wherein;
the secondary magnet structure magnetically conductive focusing pole is attached laterally outside of the vibratable portion of the diaphragm.

6. The planar-magnetic transducer of claim 1, wherein;
the secondary magnetic structure is positioned laterally outside of the vibratable portion of the diaphragm.

7. The planar-magnetic transducer of claim 1, wherein;
a first secondary magnetic structure is positioned on a first lateral side of the transducer and a second secondary magnetic structure is positioned on a second lateral side of the transducer.

8. The planar-magnetic transducer of claim 1, wherein;
the secondary magnetic structure includes an extended magnetically conductive focusing pole attached to the second polarity surface of the secondary magnet,
the extended magnetically conductive focusing pole extends over a portion of the second surface side of the vibratable portion of the diaphragm and over a portion of the conductive trace pattern,
the extended magnetically conductive focusing pole includes a polarity termination surface which is spaced a predetermined extended focusing pole gap distance away from the second surface side of the vibratable portion of the diaphragm.

9. The planar-magnetic transducer of claim 1, wherein;
the secondary magnetic structure includes an extended magnetically conductive focusing pole attached to the second polarity surface of the secondary magnet,
the extended magnetically conductive focusing pole includes a polarity termination surface and the polarity termination surface extends over a portion of the second surface side of the vibratable portion of the diaphragm and over a portion of the conductive trace pattern,
the polarity termination surface of the extended magnetically conductive focusing pole is spaced a predetermined extended focusing pole gap distance away from the second surface side of the vibratable portion of the diaphragm,
the polarity termination surface is positioned adjacent a polarity portion of a primary magnet row that has a same polarity as the extended magnetically conductive focusing pole,
the extended magnetically conductive focusing pole includes openings for increasing an acoustical transparency of the extended magnetically conductive focusing pole.

10. The planar-magnetic transducer of claim 1, wherein; at least one secondary magnetic structure is positioned at an end of the transducer.

11. The planar-magnetic transducer of claim 1, wherein; at least one magnetic structure is positioned at a first end of the transducer, and at least one secondary magnetic structure is positioned at a second end of the transducer.

12. The planar-magnetic transducer of claim 1, wherein; the primary magnetic structure has a magnetically conductive back-plate.

13. The planar-magnetic transducer of claim 1, wherein; the primary magnetic structure has a non-magnetically conductive back-plate.

14. The planar-magnetic transducer of claim 1, wherein; each primary magnet row of the primary magnetic circuit are magnetized through each magnet row in an orthogonal direction relative to a plane of the vibratable portion of the diaphragm.

15. The planar-magnetic transducer of claim 1, wherein; each primary magnet row of the primary magnetic circuit are magnetized through each magnet row in a parallel direction relative to a plane of the vibratable portion of the diaphragm and the primary magnetic structure has a non-magnetically conductive back-plate.

16. The planar-magnetic transducer of claim 1, wherein; the primary magnetic structure includes exactly of one magnet row.

17. The planar-magnetic transducer of claim 1, wherein; the primary magnetic structure includes exactly two magnet rows.

18. The planar-magnetic transducer of claim 1, wherein; the primary magnetic structure includes exactly three magnet rows.

19. The planar-magnetic transducer of claim 1, wherein; the primary magnetic structure includes exactly four magnet rows.

20. The planar-magnetic transducer of claim 1, wherein; the primary magnetic structure includes exactly five magnet rows.

21. The planar-magnetic transducer of claim 1, wherein; the primary magnetic structure includes more than five magnet rows.

22. The planar-magnetic transducer of claim 1, wherein; the primary and secondary magnetic structures include high-energy magnets with an energy product of at least 20 Mega Gauss Oersteds.

23. The planar-magnetic transducer of claim 1, wherein; the primary magnetic structure includes a high-energy magnet with an energy product of at least 20 Mega Gauss Oersteds and the secondary magnet structure includes a magnet with an energy product of less than 6 Mega Gauss Oersteds.

24. The planar magnetic transducer of claim 1, wherein;
the secondary magnetic structure includes at least one elongated magnet row with a length between 33% and 80% of a length of a longest magnet row of the at least one magnet row of the primary magnet structure.

25. The planar magnetic transducer of claim 1, wherein;
the primary magnetic structure comprises five magnet rows,
the five magnet rows consist of high-energy neodymium magnets with an energy product of greater than 30 Mega Gauss Oersteds,
the transducer includes two secondary magnet structures including magnets with an energy product of less than 6 Mega Gauss Oersteds,
the planar magnetic transducer including an enclosure to contain an acoustic energy emission from the vibratable portion of the first surface side of the diaphragm.

26. The planar-magnetic transducer of claim 1, wherein;
the secondary magnetic structure is magnetized through the magnet in an orthogonal direction relative to a plane of the vibratable portion of the diaphragm.

27. The planar-magnetic transducer of claim 1, wherein;
the secondary magnetic structure is magnetized through the secondary magnet in an parallel direction relative to a plane of the vibratable portion of the diaphragm.

28. The planar-magnetic transducer of claim 1, wherein; the conductive trace pattern consists of a single layer of conductive foil with a plane of the conductive foil in parallel with a plane of the vibratable portion of the diaphragm.

29. The planar-magnetic transducer of claim 1, comprising a first conductive trace pattern with a of a single layer of conductive foil with a plane of the conductive foil in parallel with a plane of the vibratable portion of the diaphragm and attached to the first surface side of the vibratable portion of the diaphragm, and a second conductive trace pattern with a of a single layer of conductive foil with a plane of the conductive foil in parallel with the plane of the vibratable portion of the diaphragm and attached to the second surface side of the diaphragm.

30. The planar-magnetic transducer of claim 1, further including;
a waveguide covering at least a portion of the secondary magnetic structure.

31. The planar-magnetic transducer of claim 1, wherein;
a primary magnet row closest to a lateral sidewall of the support frame has a primary magnetic polarity surface coupled to a magnetically conductive back-plate,
the primary magnetic polarity surface has a primary magnetic polarity,
the magnetically conductive back-plate is magnetically coupled through a magnetically conductive sidewall to the magnetically conductive focusing pole of the secondary magnet structure,
the first magnetic polarity surface of the secondary magnet has a secondary magnetic polarity such that the primary magnetic polarity and the secondary magnetic polarity are the same magnetic polarity.

32. The planar-magnetic transducer of claim 1, wherein the diaphragm is a thin film diaphragm.

33. The planar-magnetic transducer of claim 1, wherein;
the primary magnetic structure includes at least three primary magnet rows,
a first lateral outermost primary magnet row closest to a first sidewall of the support frame and a second lateral outermost primary magnet row closest to a second sidewall of the support frame each have a spacing gap between the first surface side of the vibratable portion of the diaphragm and a closest adjacent surface of the first and second outermost magnet rows that is less than a spacing gap between the first surface side of the vibratable portion of the diaphragm and a closest adjacent surface of at least one magnet row between the outermost magnet rows.

34. The planar-magnetic transducer of claim 1, wherein;
the primary magnetic structure includes at least two primary magnet rows and at least one passive magnetically conductive return pole row coupled to a backplate of the support frame,
the passive magnetically conductive return pole row positioned between, and in parallel with, the two primary magnet rows and spaced a predetermined distance from, the first surface side of the vibratable portion of the diaphragm.

35. A method of forming a double side magnetic field, planar magnetic transducer with increased acoustic transparency in a primary direction acoustic output, the method including the steps of;
mounting a perimeter portion of a diaphragm to a support frame such that the support frame holds a vibratable portion of the diaphragm in a predetermined state of tension;
forming a conductive trace pattern on at least one of a first surface side and a second surface side of the vibratable portion of the diaphragm;
coupling a primary magnetic structure to the support frame, where the magnetic structure includes at least one primary magnet row;
positioning the at least one primary magnet row spaced a predetermined gap distance from, and adjacent to, the vibratable portion of first surface side of the diaphragm; coupling at least one secondary magnetic structure to the support frame, where the at least one secondary magnetic structure includes at least one secondary magnet and one magnetically conductive focusing pole;
positioning the secondary magnetic structure above a plane of the second surface side of the diaphragm;
positioning the secondary magnet laterally outside of the vibratable portion of diaphragm;
attaching the magnetically conductive focusing pole to a first polarity surface of the secondary magnet;
configuring each primary magnet row to be operable as a fringe field source interacting with at least a portion of the conductive trace pattern;
configuring the magnetically conductive focusing pole of the secondary magnet structure to be operable as a focused field source interacting with at least a portion of the conductive trace pattern; and
adapting the conductive trace pattern to receive an electrical input signal.

36. The method of claim 35 further including the further steps of;
attaching an extended magnetically conductive focusing pole to a second polarity surface of the secondary magnet, where the extended magnetically conductive focusing pole includes a polarity termination surface;
positioning the polarity termination surface of the extended magnetically conductive focusing pole to extend over at least a portion of the second surface side of the vibratable portion of the diaphragm and to be spaced a predetermined extended focusing pole gap distance away from the second surface side of the diaphragm; and
configuring the extended magnetically conductive focusing pole to include openings to increase an acoustical transparency of the extended magnetically conductive focusing pole.

37. The method of claim 35 further including the further steps of;
attaching an extended magnetically conductive focusing pole, including a polarity termination surface, to a second polarity surface of the secondary magnet;
positioning the polarity termination surface of the extended magnetically conductive focusing pole to extend over at least a portion of a portion of the conductive trace pattern spaced a predetermined extended focusing pole gap distance away from the second surface side of the vibratable portion of the diaphragm;
positioning the polarity termination surface to be adjacent a polarity portion of a primary magnet row that has a same polarity as the polarity termination surface of the extended magnetically conductive focusing pole; and
configuring the extended magnetically conductive focusing pole to include openings to increase an acoustical transparency of the extended magnetically conductive focusing pole.
